(19) United States
(12) Patent Application Publication
(10) Pub. No.: US 2025/0045683 A1
(43) Pub. Date: Feb. 6, 2025

(54) INTEGRATED LOGISTICS MANAGEMENT SYSTEM AND INTEGRATED LOGISTICS MANAGEMENT METHOD

(71) Applicant: Samsung Display Co., Ltd., Yongin-si (KR)

(72) Inventors: MIN YOUNG LEE, Yongin-si (KR); JUNG-HYUK AHN, Yongin-si (KR); JAE-GU LEE, Yongin-si (KR)

(73) Assignee: Samsung Display Co., Ltd., Yongin-si (KR)

(21) Appl. No.: 18/640,368

(22) Filed: Apr. 19, 2024

(30) Foreign Application Priority Data
Aug. 1, 2023 (KR) 10-2023-0100363

(51) Int. Cl. G06Q 10/0833; G06Q 10/0835

(52) U.S. Cl. CPC G06Q 10/0833; G06Q 10/08355

(57) ABSTRACT

An integrated logistics management system including a vessel tracking server that processes transportation information about vessels by using pieces of vessel identification information received from the terminal and provides the transportation information about the vessels to the terminal. The vessel tracking server includes a vessel-map mapping part that receives pieces of navigation information of the vessels corresponding to the pieces of vessel identification information from a vessel information operator server by providing the pieces of vessel identification information to the vessel information operator server, and maps navigation routes of the vessels and real-time locations of the vessels onto a map, and a vessel-cargo mapping part that maps vessel cargo information to a corresponding vessel among the vessels.

### CROSS-REFERENCE TO RELATED APPLICATIONS

This application claims priority under 35 U.S.C. § 119 from Korean Patent Application No. 10-2023-0100363 filed on Aug. 1, 2023 in the Korean Intellectual Property Office, the contents of which are incorporated herein by reference.

### BACKGROUND

### 1. Technical Field

Embodiments of the disclosure described herein relate to an integrated logistics management system and an integrated logistics management method.

### 2. Description of the Related Art

Many companies produce, sell, and export a wide variety of goods. Logistics management may be required for companies for products thus produced. Accordingly, the companies operate various logistics management methods for efficient logistics management.

To produce, sell, and export goods, the companies need to identify a location of transportation of cargo, to calculate logistics costs of transporting cargo, to manage insurance for cargo accidents, and to manage reports from their partners. However, it may be somewhat difficult to integrate and operate these systems.

For example, an owner of goods may enter into a contract with a shipper or a freight forwarder and then may transport cargo through the shipper or freight forwarder. The shipper may be defined as a cargo transporter who transports the cargo of the owner of goods through a vessel. The freight forwarder may be defined as an organization that does not directly own the means of transportation (a vessel, an aircraft, or a truck), but has the functions and responsibilities of a transportation entity like an actual carrier.

The shipper or freight forwarder, which has entered into a contract with the owner of goods, provides the bill of lading to the owner of goods. The bill of lading may include information such as information of cargo, the container number containing the cargo, the name of a vessel that loaded the container, a departure port of the vessel, and an arrival port of the vessel.

The location of the vessel needs to be identified to accurately determine the location of cargo being transported. However, even in case that the owner of goods makes a request for information about the location of a vessel to the shipper or freight forwarder, the shipper or freight forwarder generally does not provide the location of the vessel to the owner of goods.

Even in case that the shipper or freight forwarder provides the location of the vessel to the owner of goods at the request of the owner of goods, the shipper or freight forwarder simply provides a snapshot of a current location and does not provide the detailed location of the vessel.

Moreover, the owner of goods needs to provide a bill of lading and a certain fee to the shipper or freight forwarder to identify the location of the vessel, the owner of goods needs to bear the risk of information about the bill of lading being exposed to the outside, and may incur additional costs. Continuous requests for vessel location information may result in ongoing costs.

The cargo may be transported on a plurality of routes. A company needs to predict and manage logistics costs for a plurality of routes in advance. However, because it may be difficult to calculate logistics costs for practically all routes, the company calculates logistics costs for any one route. The company calculates logistics costs for only one route as a sample and manages the logistics costs by reflecting only the one route to the entire route. Furthermore, the logistics costs may not be automatically calculated, and thus personnel in a specific department calculate the logistics costs directly.

In case that an accident occurs during the transportation of cargo, the cargo may be damaged. Companies may need an automated insurance management system for managing insurance for accidents.

In case that partners submit reports to the companies, formats and items of the reports of the partners are different from one another, and thus there may be difficulties in report management. Accordingly, the companies may need a system for integrating and managing reports.

For the above-described reasons, it may be desirable to develop a system for the integrated management of logistics.

### SUMMARY

Embodiments of the disclosure provide an integrated logistics management system for efficiently managing logistics, and an integrated logistics management method thereof.

According to an embodiment, an integrated logistics management system may include a terminal and a transportation tracking server that communicates with the terminal and processes transportation information about transportation. The transportation tracking server may include a vessel tracking server that processes transportation information about vessels by using pieces of vessel identification information received from the terminal and provides the transportation information about the vessels to the terminal. The vessel tracking server may include a vessel-map mapping part that receives pieces of navigation information of the vessels corresponding to the pieces of vessel identification information from a vessel information operator server by providing the pieces of vessel identification information to the vessel information operator server, and maps navigation routes of the vessels and real-time locations of the vessels onto a map, and a vessel-cargo mapping part that maps vessel cargo information to a corresponding vessel among the vessels.

The vessel-map mapping unit may provide the terminal with navigation information of vessels, onto which the vessel cargo information is mapped, from among the vessels, and navigation information of vessels, onto which the vessel cargo information is not mapped, from among the vessels.

The vessel tracking server may not receive a bill of lading from the terminal.

Each of the pieces of vessel identification information may include a vessel name, an international maritime organization (IMO) number, a maritime mobile service identity (MMSI) number, and a Call sign, the terminal may provide the vessel name to the vessel information operator server, and may receive the IMO number, the MMSI number, and the Call sign, which correspond to the vessel name, from the vessel information operator server, and the terminal may provide the vessel tracking server with the vessel name, the IMO number, the MMSI number, and the Call sign.

The transportation tracking server may further include a risk collecting server configured to collect risk information from a risk information providing server, and the vessel tracking server may receive the risk information from the risk collecting server, and may calculate whether the vessel, onto which the vessel cargo information is mapped is delayed, based on the risk information.

The transportation tracking server may further include a flight tracking server configured to process transportation information about an aircraft and to provide the processed transportation information to the terminal, and the flight tracking server may include a flight-map mapping part configured to receive flight information of the aircraft corresponding to a flight number by providing the flight number to a flight information providing server, and to map a flight route of the aircraft and a real-time location of the aircraft onto the map; and a flight-cargo mapping part configured to map air cargo information onto the aircraft.

The flight tracking server may further include a flight delay calculating part configured to receive the risk information from the risk collecting server, and to calculate whether the aircraft is delayed based on the risk information.

The transportation tracking server may further include a truck tracking server configured to process transportation information about a truck and to provide the processed transportation information to the terminal, and the truck tracking server may include a truck-map mapping part configured to receive driving information of the truck corresponding to truck identification information from a transportation operator server by providing the truck identification information to the transportation operator server, and to map a driving route of the truck and a real-time location of the truck onto the map; and a truck-cargo mapping part configured to map truck cargo information to the truck.

The truck tracking server may further include a truck delay calculating part configured to receive the risk information from the risk collecting server, and to calculate whether the truck is delayed, based on the risk information.

The truck-map mapping part may further receive the real-time location of the truck, which is obtained from a location tracking application matched to the truck, from a location tracking information operator server.

The truck-map mapping part may further receive the real-time location of the truck, which is obtained from a location tracking device matched to the truck, from a location tracking device operator server.

The truck tracking server may further include an optimal route calculating part configured to calculate a shortest route from a starting point to a destination as an optimal route based on road information about the starting point and the destination of the truck; and an estimated arrival time calculating part configured to calculate an estimated arrival time of the truck based on past driving records corresponding to the driving route, and in case that a plurality of shortest routes in a predetermined error range are calculated, the optimal route calculating part may set a shortest route at a low altitude as the optimal route.

The integrated logistics management system may further include a logistics cost calculating server configured to calculate a logistics cost, the logistics cost calculating server may include a cargo volume calculating part configured to calculate cargo volume by calculating total weight of next year's production products, a number of trucks to load the next year's production products, and the number of containers to load the next year's production products depending on the number of the next year's production products, per-piece weight of the next year's production products, and per-piece volume of the next year's production products; a cargo volume transportation ratio calculating part configured to determine next year's transportation routes and a transportation ratio of the next year's transportation routes based on past transportation routes of past production products corresponding to the next year's production products and a past transportation ratio of the past transportation routes, and to allocate the cargo volume to the next year's transportation routes depending on the next year's transportation routes and the next year's transportation ratio of next year's transportation routes; and a first logistics cost calculating part configured to calculate new transportation cost items for the next year's transportation routes by reflecting changed freight costs and exchange rate fluctuations to past transportation cost items for the past transportation routes, and to calculate a logistics cost for the next year's transportation routes by reflecting the new transportation cost items to the cargo volume allocated to the next year's transportation routes, the first logistics cost calculating part may receive new transportation cost items for a new transportation route among the next year's transportation routes from a user.

The cargo volume calculating part may include a cargo loading rate calculating part configured to identify a size of a cargo compartment of the trucks and a size of each of the containers, and to calculate a maximum loading quantity of a cargo box for the truck and each of the containers depending on a placement direction of a standardized cargo box to load the next year's production products, and a loading condition of the cargo box.

The next year's production products may include a first model having a past performance and a second model having no past performance, the cargo volume calculating part may receive per-piece weight and per-piece volume for the first model from a first database, and may receive per-piece weight and per-piece volume for the second model from the user, the cargo volume transportation ratio calculating part may determine next year's transportation routes and a next year's transportation ratio for the first model by using past transportation routes and a past transportation ratio of the first model, which are provided from a second database, and may determine next year's transportation routes and a next year's transportation ratio for the second model by using past transportation routes and past transportation ratio of a same product family as the second model provided from the second database, and the first logistics cost calculating part may calculate new transportation cost items for the first model by using past transportation cost items for the first model stored in the second database, and may calculate new transportation cost items for the second model by using past transportation cost items of the same product family as the second model stored in the second database.

The logistics cost calculating server may further include a per-piece logistics cost calculating part configured to calculate per-piece logistics cost for each past transportation route by dividing a logistics cost for each of the past transportation routes by a number of products transported through each of the past transportation routes; and a second logistics cost calculating part configured to allocate 100% of the cargo volume to each of the next year's transportation routes, and to calculate a logistics cost for each of next year's transportation routes by reflecting the new transportation cost items to each of the next year's transportation routes.

The integrated logistics management system may further include an insurance an accident managing server configured to manage an insurance accident in case that an accident occurs, the insurance accident managing server may include an accident registration processing part configured to receive an initial report, an interim report, and a completion report on the accident in case that the accident occurs, and to provide the terminal with the initial report, the interim report, and the completion report; and an insurance intake automation part configured to receive first essential files including an accident item, a starting point, a destination, and an accident photo from a logistics executor, to download second essential files including an invoice and a packing list from an internal server, and to submit an insurance intake file generated by using the first essential files and the second essential files to an insurer, in case that the accident is covered by insurance.

The integrated logistics management system may further include a document integrating server configured to integrate reports of partners, the document integrating server may include a partner reporting format database configured to store the reports of the partners, a master format database configured to store an integrated master format obtained by integrating items of the reports of the partners stored in the partner reporting format database; and a master format processing part configured to input the items of the reports of the partners into an item of the integrated master format.

According to an embodiment, an integrated logistics management method may include processing transportation information about vessels and providing the transportation information about the vessels to a terminal. The processing of the transportation information about the vessels may include receiving pieces of vessel identification information from the terminal, receiving pieces of navigation information of the vessels corresponding to the pieces of vessel identification information from a vessel information operator server by providing the pieces of vessel identification information to the vessel information operator server, mapping navigation routes of the vessels and real-time locations of the vessels onto a map, mapping vessel cargo information to a corresponding vessel among the vessels, collecting risk information from a risk information providing server, and calculating whether the vessel, onto which the vessel cargo information may be mapped, may be delayed based on the risk information.

The method may further include processing transportation information about an aircraft and providing the processed transportation information to the terminal, the processing of the transportation information about the aircraft may include receiving flight information of the aircraft corresponding to a flight number by providing the flight number to a flight information providing server; mapping a flight route of the aircraft and a real-time location of the aircraft onto the map; and mapping air cargo information onto the aircraft; and calculating whether the aircraft is delayed, based on the risk information.

The method may further include processing transportation information about a truck and providing the processed transportation information to the terminal, the processing of the transportation information about the truck may include receiving driving information of the truck corresponding to truck identification information from a transportation operator server by providing the truck identification information to the transportation operator server; receiving a real-time location of the truck, which is obtained from a location tracking application matched to the truck, from a location tracking information operator server by providing the truck identification information to the location tracking information operator server; receiving the real-time location of the truck, which is obtained from a location tracking device matched to the truck, from a location tracking device operator server by providing the truck identification information to the location tracking device operator server; mapping a driving route of the truck and the real-time location of the truck onto the map; mapping truck cargo information onto the truck; and calculating whether the truck is delayed, based on the risk information.

The processing of the transportation information about the truck may further include calculating a shortest route from a starting point to a destination as an optimal route based on road information about the starting point and the destination of the truck; in case that a plurality of shortest routes in a predetermined error range are calculated, setting a shortest route at a low altitude as the optimal route; and calculating an estimated arrival time of the truck based on past driving records corresponding to the driving route.

The method may also include calculating a logistics cost, the calculating of the logistics cost may include calculating cargo volume by calculating total weight of next year's production products, a number of trucks to load the next year's production products, and the number of containers to load the next year's production products depending on the number of the next year's production products, per-piece weight of the next year's production products, and per-piece volume of the next year's production products; determining next year's transportation routes and a transportation ratio of the next year's transportation routes based on past transportation routes of past production products corresponding to the next year's production products and a past transportation ratio of the past transportation routes; allocating the cargo volume to the next year's transportation routes depending on the next year's transportation routes and the transportation ratio of the next year's transportation routes; calculating new transportation cost items for the next year's transportation routes by reflecting changed freight costs and exchange rate fluctuations to past transportation cost items for the past transportation routes; receiving new transportation cost items for a new transportation route among the next year's transportation routes from a user; and calculating a logistics cost for the next year's transportation routes by reflecting the new transportation cost items to the cargo volume allocated to the next year's transportation routes.

The calculating of the cargo volume may include calculating a maximum loading quantity of a cargo box for a truck and each of the containers depending on a placement direction of a standardized cargo box to load the next year's production products, and a loading condition of the cargo box.

The next year's production products may include a first model having a past performance and a second model having no past performance, per-piece weight and per-piece volume for the first model may be provided from a first database, and per-piece weight and per-piece volume for the second model may be provided from the user, next year's transportation routes and a next year's transportation ratio for the first model may be determined by using past transportation routes and a past transportation ratio of the first model, which are stored in a second database, next year's transportation routes and a next year's transportation ratio for the second model may be determined by using past transportation routes and past transportation ratio of a same product family as the second model stored in the second database, new transportation cost items for the first model may be calculated by using past transportation cost items for the first model stored in the second database, and new transportation cost items for the second model may be calculated by using past transportation cost items of the same product family as the second model stored in the second database.

The method may also include calculating per-piece logistics cost for each of the past transportation routes by dividing a logistics cost for each of the past transportation routes by a number of products transported through each of the past transportation routes; allocating 100% of the cargo volume to each of the next year's transportation routes; and calculating a logistics cost for each of next year's transportation routes by reflecting the new transportation cost items to each of the next year's transportation routes.

### BRIEF DESCRIPTION OF THE DRAWINGS

The above and other objects and features of the disclosure will become apparent by describing in detail embodiments thereof with reference to the accompanying drawings.

FIG. 1 is a block diagram of an integrated logistics management system, according to an embodiment of the disclosure.

FIG. 2 is a block diagram of a transportation tracking server shown in FIG. 1.

FIG. 3 is a block diagram of a vessel tracking server shown in FIG. 2.

FIGS. 4 to 6 are diagrams showing screens for navigation information of vessels, which is capable of being displayed on a goods-owner terminal, according to an operation of a transportation tracking server.

FIG. 7 is a flowchart for describing an operation of a vessel tracking server shown in FIG. 3.

FIG. 8 is a block diagram of a flight tracking server shown in FIG. 2.

FIGS. 9 and 10 are diagrams showing screens for flight information of an aircraft, which is capable of being displayed on a goods-owner terminal, according to an operation of a transportation tracking server.

FIG. 11 is a flowchart for describing an operation of a flight tracking server shown in FIG. 8.

FIG. 12 is a block diagram of a truck tracking server shown in FIG. 2.

FIGS. 13 and 14 are diagrams showing routes to a starting point and destination of a truck.

FIGS. 15 and 16 are diagrams showing screens for driving information of a truck, which is capable of being displayed on a goods-owner terminal, according to an operation of a transportation tracking server.

FIG. 17 is a flowchart for describing an operation of a truck tracking server shown in FIG. 12.

FIG. 18 is a diagram for describing an operation of a transportation integration tracking server shown in FIG. 2.

FIGS. 19 and 20 are diagrams showing screens for integrated transportation information capable of being displayed on a goods-owner terminal according to an operation of a transportation integration tracking server.

FIG. 21 is a flowchart for describing an operation of a transportation integration tracking server shown in FIG. 18.

FIG. 22 is a block diagram of a logistics cost calculating server shown in FIG. 1.

FIG. 23 is a flowchart for describing an operation of a cargo volume calculating part shown in FIG. 22.

FIG. 24 is a flowchart for describing an operation of a cargo loading rate calculating part shown in FIG. 22.

FIG. 25 is a diagram for describing a method of calculating a maximum loading rate for a truck or container.

FIG. 26 is a flowchart for describing an operation of a cargo volume transportation ratio calculating part for each route shown in FIG. 22.

FIGS. 27 to 29 are diagrams showing various routes through which products are transported.

FIG. 30 is a flowchart for describing an operation of a first logistics cost calculating part shown in FIG. 22.

FIGS. 31 and 32 are flowcharts for describing an operation of a per-piece logistics cost calculating part shown in FIG. 22.

FIG. 33 is a flowchart for describing an operation of a second logistics cost calculating part shown in FIG. 22.

FIG. 34 is a diagram showing cargo volume allocated to routes in case that an operation of a second logistics cost calculating part shown in FIG. 33 is reflected to routes for a first model shown in FIG. 27.

FIG. 35 is a block diagram of an insurance accident managing server shown in FIG. 2.

FIG. 36 is a flowchart for describing an operation of an accident registration processing part shown in FIG. 35.

FIG. 37 is a flowchart for describing an operation of an insurance intake automation part shown in FIG. 35.

FIG. 38 is a block diagram of a document integrating server shown in FIG. 2.

FIG. 39 is a flowchart for describing an operation of a document integrating server shown in FIG. 38.

FIG. 40 is a diagram showing an integrated master format processed depending on an operation of a document integrating server shown in FIG. 38.

### DETAILED DESCRIPTION OF THE EMBODIMENTS

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

In case that an embodiment may be implemented differently, a specific process order may be performed differently from the described order. For example, two consecutively described processes may be performed substantially at the same time or performed in an order opposite to the described order. Also, like reference numerals and/or reference characters denote like elements.

Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” in case that used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, parts, and/or modules. Also, each block, part, and/or module of some embodiments may be physically separated into two or more interacting and discrete blocks, parts, and/or modules without departing from the scope of the inventive concepts. Further, the blocks, parts, and/or modules of some embodiments may be physically combined into more complex blocks, parts, and/or modules without departing from the scope of the inventive concepts.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

Hereinafter, embodiments of the disclosure will be described with reference to accompanying drawings.

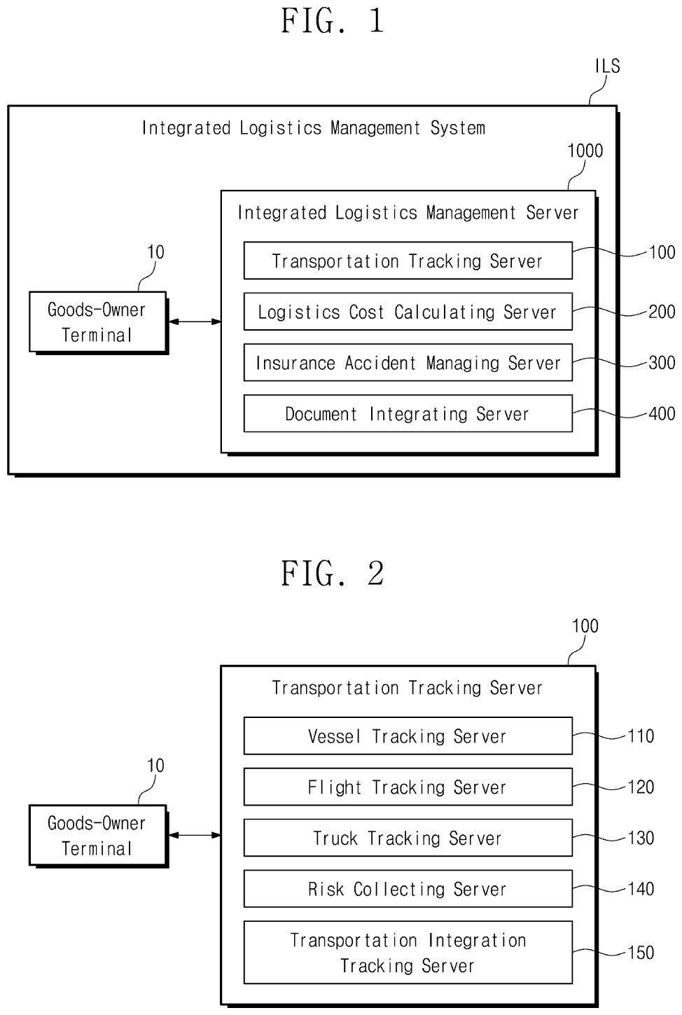

FIG. 1 is a block diagram of an integrated logistics management system, according to an embodiment of the disclosure.

Referring to FIG. 1, an integrated logistics management system ILS according to an embodiment of the disclosure may include a goods-owner terminal 10 and an integrated logistics management server 1000 for providing various pieces of information to the goods-owner terminal 10.

Hereinafter, a “terminal” may be defined as a digital device, which includes a memory means and has the computing capability by mounting a microprocessor, such as a mobile communication terminal, a desktop computer, a laptop computer, and a personal digital assistant (PDA).

Hereinafter, in this specification, a “server” may be defined as a computer that provides a user with various pieces of information through various computational operations by including pieces of software and storage devices. Moreover, in this specification, a “part” may be defined as a module that includes software or hardware that performs a specific function.

The integrated logistics management server 1000 may provide various pieces of information to the goods-owner terminal 10 at the request of the owner of goods by communicating with the goods-owner terminal 10 in a wired or wireless method. The owner of goods may receive various pieces of information from the integrated logistics management server 1000 through the goods-owner terminal 10. The integrated logistics management server 1000 may be owned by the owner of goods. The owner of goods may be defined as a user who employs the integrated logistics management server 1000.

The integrated logistics management server 1000 may provide the goods-owner terminal 10 with a route of the transportation means for carrying cargo and a real-time location of the transportation means. The integrated logistics management server 1000 may calculate estimated logistics costs for the next year and may provide the goods-owner terminal 10 with the estimated logistics costs for the next year. The integrated logistics management server 1000 may process and manage insurance accidents. The integrated logistics management server 1000 may integrate and manage reports from partners.

To process the pieces of information, the integrated logistics management server 1000 may include a transportation tracking server 100, a logistics cost calculating server 200, an insurance accident managing server 300, and a document integrating server 400.

The transportation tracking server 100 may map the route of transportation for loading cargo and the real-time location of the transportation onto a map and may provide the goods-owner terminal 10 with the mapped result. The owner of goods may identify the route of the transportation for loading cargo, and the real-time location of the transportation through the goods-owner terminal 10.

The logistics cost calculating server 200 may calculate the estimated logistics costs for each transportation route for products to be produced in the next year (referred to as “next year's production products”) and may provide the estimated logistics costs to the goods-owner terminal 10. The owner of goods may identify the estimated logistics costs for each transportation route for the next year's production products through the goods-owner terminal 10.

In case of an accident in a transportation means transporting cargo, the insurance accident managing server 300 may manage insurance accidents. The insurance accident managing server 300 may receive a report on an accident. In case that the accident is covered by insurance, the insurance accident managing server 300 may submit insurance documents to an insurer by using essential files required for insurance and insurance intake files. The insurance accident managing server 300 may provide the owner of goods with an insurance processing status of the insurer through the goods-owner terminal 10.

The document integrating server 400 may manage reporting items of the partners by entering the reporting items into items of an integrated master format. The integrated master format may be provided to the goods-owner terminal 10 through the document integrating server 400. The owner of goods may receive the integrated master format through the goods-owner terminal 10 and may identify reporting items of partners.

FIG. 2 is a block diagram of a transportation tracking server shown in FIG. 1.

Referring to FIG. 2, the transportation tracking server 100 may communicate with the goods-owner terminal 10 through wired or wireless communication. The cargo of an owner of goods may be transported by a variety of modes of transportation, including vessels, aircraft, and trucks. The transportation tracking server 100 may process transportation information about transportation and may provide the information about transportation to the owner of goods through the goods-owner terminal 10 at the request of the owner of goods.

The transportation tracking server 100 may include a vessel tracking server 110, a flight tracking server 120, a truck tracking server 130, a risk collecting server 140, and a transportation integration tracking server 150.

The vessel tracking server 110 may process transportation information about vessels by using pieces of vessel identification information received from the goods-owner terminal 10 and may provide the processed transportation information about vessels to the goods-owner terminal 10. The transportation information about vessels may include navigation information of vessels and information about vessel cargo loaded on the vessels.

The flight tracking server 120 may process transportation information about aircraft and may provide the processed transportation information about aircraft to the goods-owner terminal 10. The transportation information about aircraft may include flight information about aircraft and information about air cargo loaded on the aircraft.

The truck tracking server 130 may process transportation information about trucks and may provide the processed transportation information about trucks to the goods-owner terminal 10. The transportation information about trucks may include driving information of trucks and information about truck cargo loaded on trucks.

The risk collecting server 140 may collect and store various pieces of risk information capable of affecting transportation from a risk information providing server. Details about the risk information providing server and the risk information will be described later. The risk information of the risk collecting server 140 may be provided to the vessel tracking server 110, the flight tracking server 120, and the truck tracking server 130.

The vessel tracking server 110 may receive risk information from the risk collecting server 140 and may calculate whether vessels loaded with cargo may be delayed based on the risk information. The vessel tracking server 110 may provide the goods-owner terminal 10 with information about whether the vessels may be delayed.

The flight tracking server 120 may receive risk information from the risk collecting server 140 and may calculate whether aircraft may be delayed based on the risk information. The flight tracking server 120 may provide the goods-owner terminal 10 with information about whether the aircraft may be delayed.

The truck tracking server 130 may receive risk information from the risk collecting server 140 and may calculate whether trucks may be delayed based on the risk information. The truck tracking server 130 may provide the goods-owner terminal 10 with information about whether trucks may be delayed.

The transportation integration tracking server 150 may receive transportation information of vessels, aircraft, and trucks, which may be loaded with cargo, from the vessel tracking server 110, the flight tracking server 120, and the truck tracking server 130 and may integrate transportation information of vessels, aircraft, and trucks, which may be loaded with the cargo. The transportation integration tracking server 150 may integrate transportation information of vessels, aircraft, and trucks, which may be loaded with the cargo, and may provide the goods-owner terminal 10 with the transportation information.

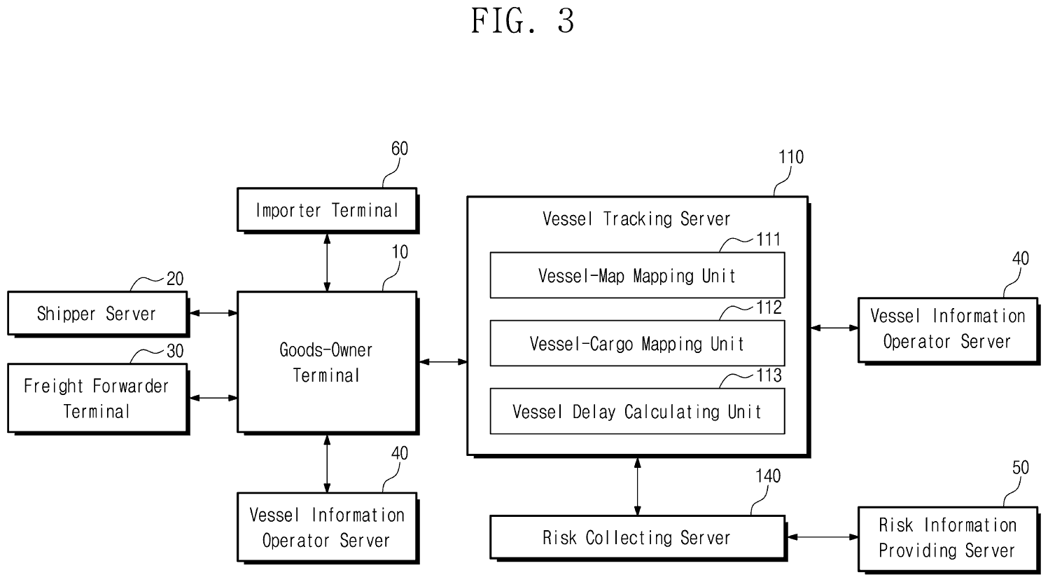

FIG. 3 is a block diagram of a vessel tracking server shown in FIG. 2.

Referring to FIG. 3, the goods-owner terminal 10 may receive a bill of lading from a shipper server 20 or a freight forwarder terminal 30. The bill of lading may include the name of a vessel onto which cargo of an owner of goods may be loaded. The vessel name may be defined as vessel identification information. The goods-owner terminal 10 may obtain additional vessel identification information by using the vessel name.

According to navigation laws, locations of vessels need to be disclosed, and the vessels may transmit navigation information in real time. The navigation information about vessels may be transmitted through automatic identification system (AIS). The AIS may be defined as an automatic vessel identification device. The AIS may be defined as navigation equipment capable of automatically transmitting and receiving information such as a vessel's location, speed, course, and vessel identification information through wireless communication (VHF frequency) to enhance the navigational safety and security of the vessel.

In particular, AIS data transmitted through AIS may include various pieces of information such as a vessel name, an international maritime organization (IMO) number, a maritime mobile service identity (MMSI) number, a Call sign, vessel specifications, a vessel speed, a vessel location, a vessel's navigation route, and the vessel's starting point (or a departure port), the vessel's destination (or an arrival port), the vessel's estimated arrival time, and cargo information.

The IMO number may be defined as an IMO registration number. The IMO number may be composed of 7 digits as a unique serial number assigned to each vessel, and may be used to register and track a vessel. The MMSI number may be defined as a maritime mobile service identification number. The MMSI number may be composed of 9 digits. The Call sign may be an international Call sign and may be a unique number attached to a ship.

In case that a vessel is close to a port, the AIS data transmitted from the vessel may be received through an antenna of the port and may be stored in a port authority server. In case that a vessel is far from the port, the AIS data transmitted from the vessel may be transmitted through a satellite and may be received through a satellite station. This AIS data may be stored on the satellite company server. A vessel information operator server 40 may receive and store navigation information about vessels from the port authority server and the satellite company server.

The goods-owner terminal 10 may provide the vessel name to the vessel information operator server 40 and may receive the IMO number, the MMSI number, and the Call sign corresponding to the vessel name. The vessel name, the IMO number, the MMSI number, and the Call sign may be defined as vessel identification information. In other words, the owner of goods may obtain the vessel identification information including the IMO number, the MMSI number, and the Call sign through the vessel information operator server 40.

The goods-owner terminal 10 may access the vessel information operator server 40 through a communication part (not shown). Moreover, the vessel tracking server 110 may also access the vessel information operator server 40 via a communication part. The goods-owner terminal 10 may also access the vessel tracking server 110 through a communication part. Hereinafter, embodiments of the disclosure will be described assuming that a connection between a terminal and a server and a connection between servers may be performed by the communication part.

The vessel name, the IMO number, the MMSI number, and the Call sign may be provided to the vessel tracking server 110 via the goods-owner terminal 10 and may be stored on the vessel tracking server 110. The vessel tracking server 110 may store pieces of vessel identification information of vessels loaded with cargo of the owner of goods in the past and pieces of vessel identification information of vessels loaded with the cargo of the owner of goods in the present. In other words, the vessel tracking server 110 may store pieces of vessel identification information about vessels that have been used in the past as well as vessels that may be currently used.

The vessel tracking server 110 may include a vessel-map mapping part 111, a vessel-cargo mapping part 112, and a vessel delay calculating part 113. The pieces of vessel identification information of vessels may be stored in the vessel-map mapping part 111.

The owner of goods may request navigation information of vessels, onto each of which cargo of the owner of goods may be loaded, as well as navigation information of other vessels onto each of which cargo of the owner of goods may not be loaded. This selection operation may be performed as the owner of goods requests the vessel-map mapping part 111 to perform a selection operation through the goods-owner terminal 10. The vessel-map mapping part 111 may provide the vessel information operator server 40 with pieces of vessel identification information requested from the goods-owner terminal 10 among the pieces of vessel identification information.

The vessel-map mapping part 111 may provide pieces of vessel identification information to the vessel information operator server 40 and may receive pieces of navigation information of vessels corresponding to the pieces of vessel identification information from the vessel information operator server 40. Among the navigation information for each of vessels stored in the vessel information operator server 40, a vessel specification, a vessel speed, a vessel location, a vessel navigation route, a vessel's starting point (or a departure port), the vessel's destination (or an arrival port), and the vessel's estimated arrival time may be defined as navigation information.

At the request of the owner of goods, the vessel-map mapping part 111 may map pieces of navigation information of vessels onto a map and may provide the goods-owner terminal 10 with the pieces of navigation information mapped to the map. For example, in case that the owner of goods requests navigation routes of vessels and real-time locations of the vessels through the goods-owner terminal 10, the vessel-map mapping part 111 may map the navigation routes of vessels and the real-time locations of vessels on a map and may provide the goods-owner terminal 10 with the mapped result.

In an embodiment of the disclosure, the map mapping operation may include displaying information as a separate list on left and right screens or upper and lower screens of a screen, on which the map may be displayed, in addition to displaying information on an actual map screen.

At the request of the owner of goods through the goods-owner terminal 10, the vessel-map mapping part 111 may map a vessel specification of each vessel, a vessel speed, a vessel location, a vessel navigation route, a vessel's starting point (or a departure port), the vessel's destination (or an arrival port), or the vessel's estimated arrival time on a map and may provide the goods-owner terminal 10 with the mapped result.

Additionally, the vessel information operator server 40 may receive weather information corresponding to a current location of each vessel from a weather information providing server (not shown) and may provide the vessel-map mapping part 111 with the weather information. At the request of the owner of goods, the vessel-map mapping part 111 may map the weather information onto a map and may provide the goods-owner terminal 10 with the mapped result.

Because the vessel information operator server 40 continuously stores pieces of navigation information of vessels, pieces of past navigation information of vessels may also be stored in the vessel information operator server 40. The vessel information operator server 40 may provide the vessel-map mapping part 111 with information about a previous route (or a navigation route) history of each of vessels. The vessel information operator server 40 may provide the vessel-map mapping part 111 with information about a past route, on which a vessel passed through at least five ports, as the previous route of each vessel.

At the request of the owner of goods, the vessel-map mapping part 111 may map information about the previous route history of each vessel onto a map and may provide the goods-owner terminal 10 with the mapped result. Accordingly, the owner of goods may identify the previous route history of each vessel through the goods-owner terminal 10.

Hereinafter, in the description of the vessel tracking server 110, a vessel loaded with cargo and a vessel not loaded with cargo among multiple vessels will be described as an example.

The vessel-cargo mapping part 112 may map vessel cargo information onto the corresponding vessel among the vessels. The vessel cargo information may be defined as information about cargo of the owner of goods, which may be loaded on the vessel. The vessel cargo information entered through the goods-owner terminal 10 may be stored in the vessel-cargo mapping part 112.

The vessel cargo information may also be mapped and provided to the goods-owner terminal 10. For example, the vessel-map mapping part 111 may map navigation information of a vessel, onto which the vessel cargo information may be mapped, from among the vessels onto a map and may provide the goods-owner terminal 10 with the mapped result. Accordingly, the owner of goods may identify the vessel cargo information and the vessel onto which cargo of the owner of goods may be loaded.

As described above, navigation information about a vessel onto which cargo may not be loaded may also be provided to the goods-owner terminal 10. For example, the vessel-map mapping part 111 may provide the goods-owner terminal 10 with navigation information of a vessel, onto the vessel cargo information may not be mapped, from among the vessels.

The owner of goods may identify pieces of navigation information of various vessels depending on an operation of the vessel tracking server 110. A vessel onto which cargo may be scheduled to be loaded may fail to sail for reasons such as breakdowns. The owner of goods may request a specific vessel, onto which cargo of the owner of goods may not be loaded, from among surrounding vessels identified through the vessel-map mapping part 111 to load the cargo.

In an embodiment of the disclosure, the owner of goods may readily identify the navigation route and real-time location of each vessel without providing a bill of lading to the shipper or freight forwarder. Furthermore, the vessel tracking server 110 does not receive the bill of lading from the goods-owner terminal 10, but only receives vessel identification information, thereby making it possible to readily obtain the navigation route and real-time location of each vessel.

The risk collecting server 140 may receive risk information from a risk information providing server 50. The risk collecting server 140 may receive risk information from the risk information providing server 50 in an application programming interface (API) or robotic process automation (RPA) method.

The risk information providing server 50 may provide various pieces of risk information. The risk collecting server 140 may collect the risk information through a risk information providing server such as GDACS, RSOE, or CRYSIS 24.

The risk information includes various pieces of information capable of affecting transportation, such as weather information according to typhoons and rainstorms, landslides, floods, tsunamis, port closures, airport closures, strikes, wars, terrorism, earthquakes, political situations, and pirates. The risk collecting server 140 may receive and store this risk information.

The vessel delay calculating part 113 may receive the risk information from the risk collecting server 140 and may calculate whether a vessel, onto which vessel cargo information may be mapped, may be delayed based on the risk information. In other words, the vessel delay calculating part 113 may calculate whether the vessel carrying cargo of the owner of goods may be delayed.

The vessel delay calculating part 113 may receive the risk information corresponding to the vessel's navigation route by making a request for the risk information to the risk information providing server 50. The vessel delay calculating part 113 may determine whether the risk information may be capable of affecting an operation of the vessel.

For example, in case that weather at a port worsens due to high waves due to wind and rain, a vessel may not depart from the port, and thus the vessel may fail to arrive at a destination as scheduled. The vessel delay calculating part 113 may determine that the vessel may be in a delay state based on this weather risk information.

While the vessel may be sailing, the vessel's movement route may overlap a typhoon's movement route. The vessel may need to evacuate to an adjacent port or may reduce its speed to avoid overlapping the typhoon's route. Accordingly, the vessel may not arrive at the destination as scheduled. The vessel delay calculating part 113 may determine that the vessel may be in a delay state based on this weather risk information.

In case that a destination port is closed due to war or terrorism, the vessel may sail to divert to another port. Accordingly, the vessel may not arrive at the destination as scheduled. The vessel delay calculating part 113 may determine that the vessel may be in a delay state based on this risk information.

In the event that another vessel may be hijacked by pirates, the vessel may sail in a detour to avoid a point where the pirates appear. Accordingly, the vessel may not arrive at its destination as planned, and thus the vessel delay calculating part 113 may determine that the vessel may be in a delay state based on this risk information.

The vessel delay calculating part 113 may determine the delay state of the vessel based on the risk information. Moreover and additionally, in case that the vessel may be delayed, the vessel delay calculating part 113 may predict a delay time of the vessel by calculating the delay time of the vessel. For example, the vessel delay calculating part 113 may calculate the delay time of the vessel by using a period in time during which the vessel was anchored in a port because the vessel failed to sail, a period in time during which the vessel was anchored in the port from which the vessel took refuge, a distance of a navigation route along which the vessel bypassed, and the speed of the vessel.

The delay state of the vessel, the estimated delay time of the vessel, and the risk information that affected the delay of the vessel may be mapped onto the map and then may be provided to the goods-owner terminal 10. For example, the vessel-map mapping part 111 may map the delay state of the vessel, the estimated delay time of the vessel, and the risk information that affected the delay of the vessel onto the map and may provide the goods-owner terminal 10 with the mapped result.

The owner of goods may identify the delay state of the vessel, onto which cargo of the owner of goods may be loaded, the estimated delay time of the vessel, and risk information that affected the delay of the vessel through the goods-owner terminal 10. The delay state of a vessel may be displayed in various colors depending on the number of delay days.

The owner of goods may provide the vessel's delay state and the vessel's estimated delay time to an importer terminal 60 through the goods-owner terminal 10. An importer may be a business operator that manufactures products by using cargo of the owner of goods, and may send trucks to transport the cargo to a port and may start a preliminary operation of a factory in accordance with the cargo's expected arrival time. The owner of goods may provide the importer with display panels having various models. The importer may be a company that manufactures display devices, which may be final products, by using the display panels.

In case that the importer does not know the delay state of the vessel, the business operator may send trucks to the port to load the cargo at the normal arrival time and may have the trucks wait. However, the cargo does not arrive at the port due to vessel delays, and thus the trucks may need to continuously wait at the port, resulting in cost and time loss.

Moreover, in case that the importer does not know the delay state of the vessel, the importer may start a preliminary operation of a factory in accordance with the normal arrival date. However, the cargo does not arrive at the port due to vessel delays, and thus the preliminary operation of the factory needs to be stopped, resulting in cost and time loss.

However, in an embodiment of the disclosure, the delay state of the vessel and the estimated delay time of the vessel may be notified to the importer. Accordingly, the importer may send trucks to transport cargo to the port and may start the preliminary operation of the factory in accordance with the delay date. Accordingly, costs and time loss due to vessel delay may not occur.

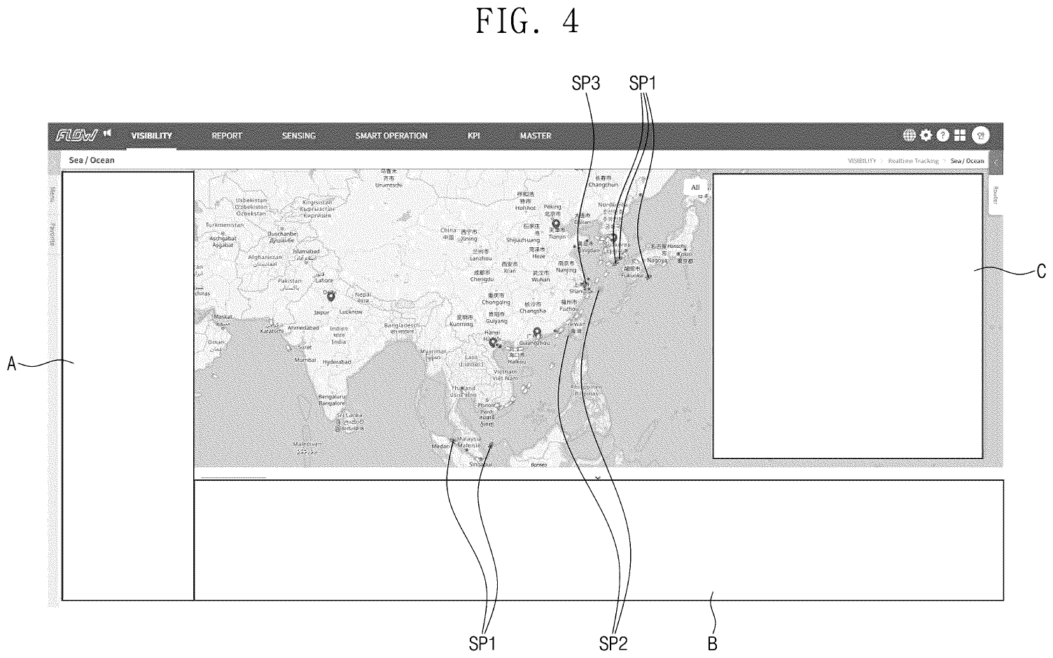

FIGS. 4 to 6 are diagrams showing screens for navigation information of vessels, which may be capable of being displayed on a goods-owner terminal, according to an operation of a transportation tracking server.

In FIGS. 4 to 6, various information lists displayed around a map may be redacted for security reasons. Hereinafter, information displayed in blocks A to E will be briefly described in the detailed description.

Referring to FIG. 4, real-time locations of vessels may be displayed in various colors and may be visually provided to an owner of goods. Vessels SP1, SP2, and SP3 onto each of which cargo of the owner of goods may be loaded may be displayed in various colors. The vessels SP1 operating normally may be displayed in blue. The vessels SP2 expected to be delayed by one day may be displayed in yellow. The vessel SP3 expected to be delayed by two days or more may be displayed in red.

Vessels onto each of which the cargo of the owner of goods may not be loaded may be displayed in white. For example, no mark may be shown on vessels displayed in white.

Information about vessel names, starting points, destinations, and vessel types (whether a vessel may be a ship or ferry), and sailing time may be displayed in block A on a left side of the map and may be visually provided to the owner of goods. Regardless of whether the cargo of the owner of goods has been loaded, information about vessels may be displayed in block A.

Pieces of information about a list of cargo of the owner of goods loaded onto the vessels SP1, SP2, and SP3 may be displayed in block B at the bottom of the map and may be visually provided to the owner of goods. Operation statuses of the vessels SP1, SP2, and SP3 onto which the cargo of the owner of goods may be loaded may be displayed in block C on the right side of the map and may be provided visually to the owner of goods. Whether vessels may be normally reached, whether the vessels may be delayed, and the number of delay days may be displayed in the operation statuses of the vessels SP1, SP2, and SP3.

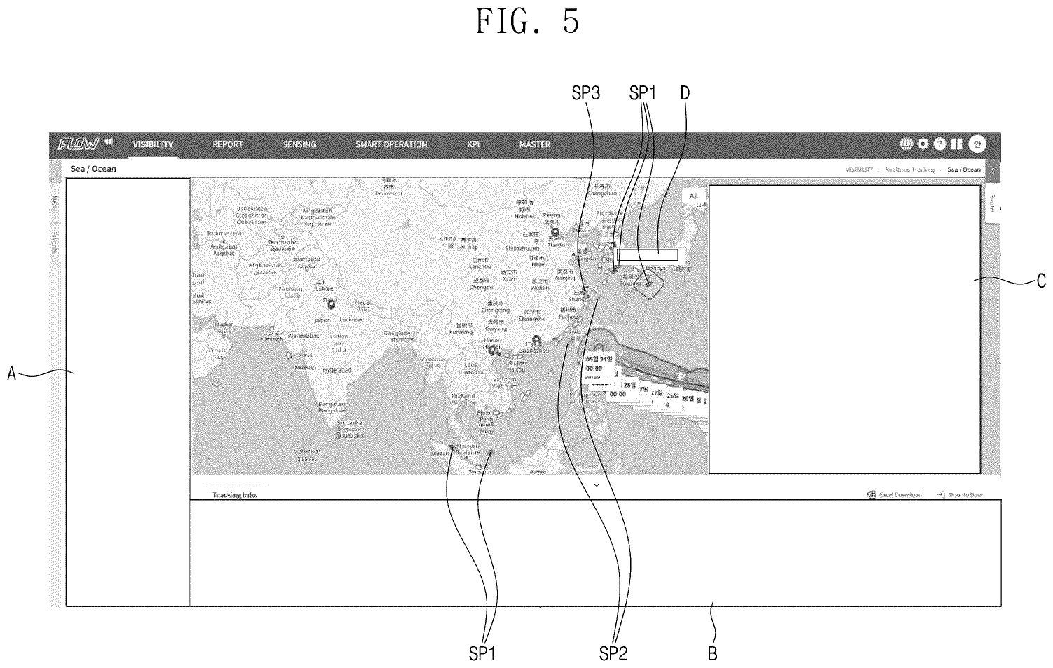

Referring to FIG. 5, information about a typhoon may be displayed as risk information and may be visually provided to the owner of goods. For example, the typhoon's movement route and the time of the typhoon's movement point may be displayed. Besides, the vessel name of the selected vessel may be displayed in block D by selecting a specific vessel (a portion displayed in a diamond shape).

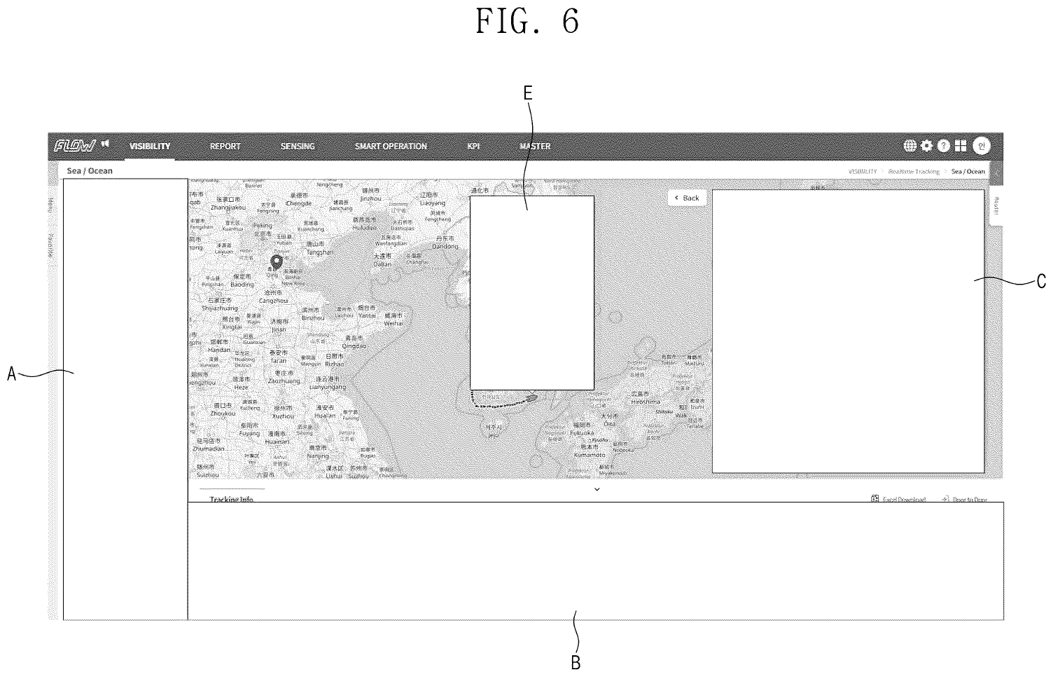

Referring to FIG. 6, navigation information of the selected vessel may be displayed in block E by additionally clicking a specific vessel (displaying the movement of a dotted line). A navigation progress rate of the selected vessel from a starting point to a destination, a latitude and longitude location of the selected vessel, meteorological information about the location of the selected vessel, and whether the vessel may be sailing on a normal route may be displayed in block E.

Independently of block E, departure information about the selected vessel, expected arrival information about the selected vessel, a delay state for the selected vessel, and the number of delay days may be additionally displayed in block C.

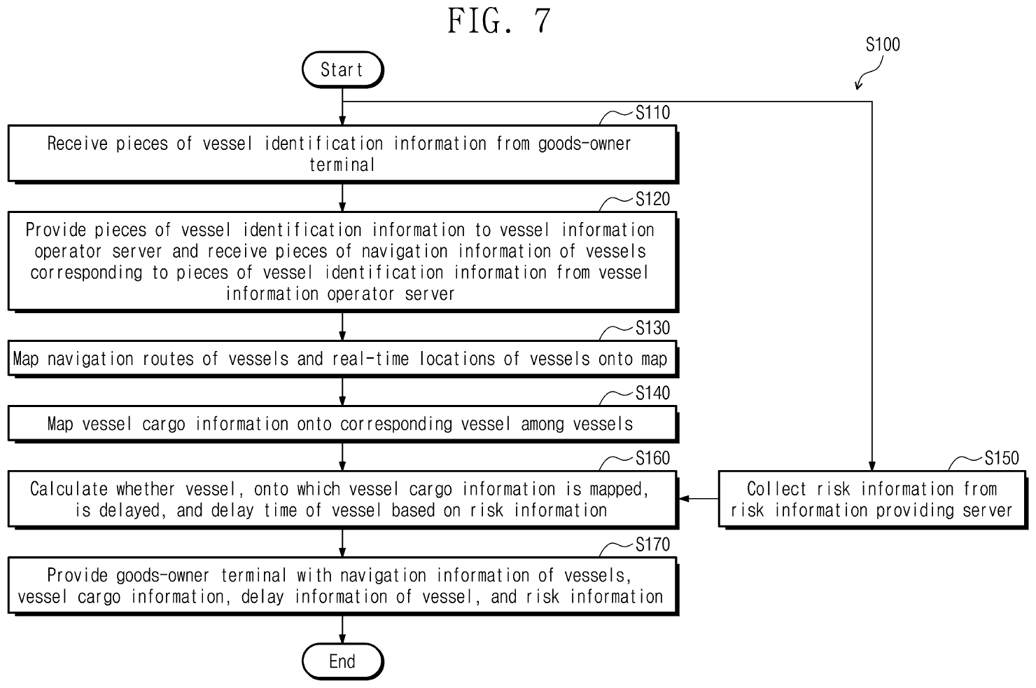

FIG. 7 is a flowchart for describing an operation of a vessel tracking server shown in FIG. 3.

Referring to FIGS. 3 and 7, the vessel tracking server 110 may process transportation information about vessels and may provide the goods-owner terminal 10 with the processed transportation information. For this operation, operation S100 of processing transportation information about vessels may include operations S110 to S170 shown in FIG. 7.

In operation S110, the vessel tracking server 110 may receive pieces of vessel identification information from the goods-owner terminal 10. In operation S120, the vessel tracking server 110 may provide the pieces of vessel identification information to the vessel information operator server 40 and may receive pieces of navigation information of vessels corresponding to the pieces of vessel identification information from the vessel information operator server 40.

In operation S130, the vessel tracking server 110 may map navigation routes of the vessels and real-time locations of the vessels onto a map. In operation S140, the vessel tracking server 110 may map vessel cargo information onto the corresponding vessel among the vessels.

In operation S150, the risk collecting server 140 may collect risk information from a risk information providing server 50. Operation S150 may be separately performed independently of operations S110 to S140.

The procedure may proceed to operation S160 after operations S140 and S150. In operation S160, the vessel tracking server 110 may calculate whether a vessel, onto which vessel cargo information may be mapped, may be delayed, and a delay time of the vessel based on risk information.

In operation S170, the vessel tracking server 110 may provide the goods-owner terminal 10 with the navigation information of a vessel, the vessel cargo information, the delay information of the vessel, and the risk information. The navigation information of a vessel may be navigation information of a vessel onto which the vessel cargo information may be mapped. However, an embodiment may not be limited thereto. As described above, the navigation information of a vessel may include navigation information of a vessel onto which vessel cargo information may not be mapped.

The vessel cargo information may be information about cargo loaded onto a vessel. The delay information of a vessel may include information about whether a vessel, onto which vessel cargo information may be mapped, may be delayed, and a delay time of the vessel. The risk information may be risk information that affected the delay of a vessel.

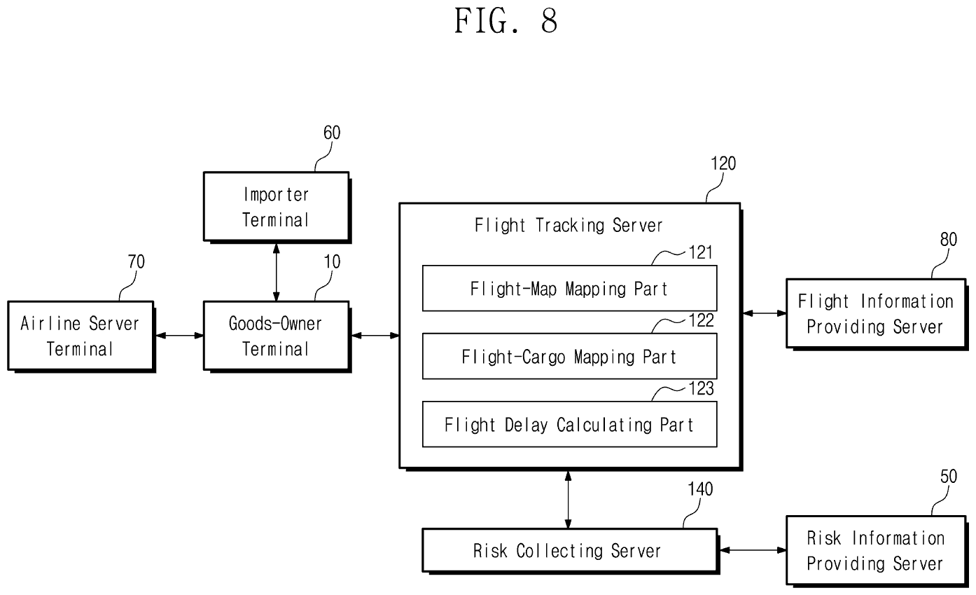

FIG. 8 is a block diagram of a flight tracking server shown in FIG. 2.

Hereinafter, in FIG. 8, a tracking operation for one of aircraft, onto each of which cargo may be loaded may be described.

Referring to FIG. 8, the goods-owner terminal 10 may receive the flight number for an aircraft carrying cargo of an owner of goods from an airline server 70. The goods-owner terminal 10 may provide the flight number to the flight tracking server 120. The flight tracking server 120 may obtain flight information of the aircraft carrying the cargo of the owner of goods by using the flight number.

The flight tracking server 120 may include a flight-map mapping part 121, a flight-cargo mapping part 122, and a flight delay calculating part 123.

The flight-map mapping part 121 may receive and store the flight number from the goods-owner terminal 10. The flight-map mapping part 121 may provide the flight number to a flight information providing server 80 and may receive flight information of an aircraft corresponding to the flight number from the flight information providing server 80.

The flight-map mapping part 121 may receive the flight information of the aircraft by accessing the flight information providing server 80, such as Flightaware® server or Flightrader24® server. The flight-map mapping part 121 may receive the flight information of the aircraft from the flight information providing server 80 through a robotic process automation (RPA) method. The flight information of the aircraft may include information such as the aircraft's flight route, real-time location, starting point, destination, and flight time.

The flight-map mapping part 121 may map information of the aircraft's flight route, real-time location, starting point, destination, and flight time onto a map. The flight-map mapping part 121 may map the aircraft's flight information onto the map and may provide the goods-owner terminal 10 with the mapped result. The owner of goods may identify the flight information of the aircraft carrying the cargo through the goods-owner terminal 10.

The flight-cargo mapping part 122 may map air cargo information onto the aircraft. The air cargo information may be defined as information about cargo of the owner of goods, which may be loaded on the aircraft. The air cargo information may also be mapped and provided to the goods-owner terminal 10. For example, the flight-map mapping part 121 may map the flight information of the aircraft, onto which the air cargo information may be mapped, onto the map and may provide the goods-owner terminal 10 with the mapped result. Accordingly, the owner of goods may identify the air cargo information and the aircraft onto which the cargo of the owner of goods may be loaded.

The flight delay calculating part 123 may receive risk information from the risk collecting server 140 and may calculate whether an aircraft may be delayed based on the risk information. The flight delay calculating part 123 may receive the risk information corresponding to the aircraft's flight route by making a request for the risk information to the risk information providing server 50. The flight delay calculating part 123 may determine whether the risk information may be capable of affecting an operation of the aircraft.

For example, in case that the aircraft is incapable of departing from an airport due to bad weather such as a typhoon, the flight delay calculating part 123 may determine that the aircraft may be in a delay state based on the meteorological risk information.

In case that a destination airport is closed due to wars, terrorism, explosion, or fire, the aircraft may divert to another airport. The flight delay calculating part 123 may determine that the aircraft may be in a delay state based on this risk information.

The flight delay calculating part 123 may determine the delay state of the aircraft based on the risk information. The delay state of the aircraft and the risk information that affected the delay of the aircraft may be mapped onto the map and then may be provided to the goods-owner terminal 10. For example, the flight-map mapping part 121 may map the delay state of the aircraft and the risk information that affected the delay of the aircraft onto a map and may provide the goods-owner terminal 10 with the mapped result.

The owner of goods may identify the delay state of the aircraft, onto which cargo of the owner of goods may be loaded, and risk information that affected the delay of the aircraft through the goods-owner terminal 10. The owner of goods may provide the aircraft's delay information to the importer terminal 60 through the goods-owner terminal 10.

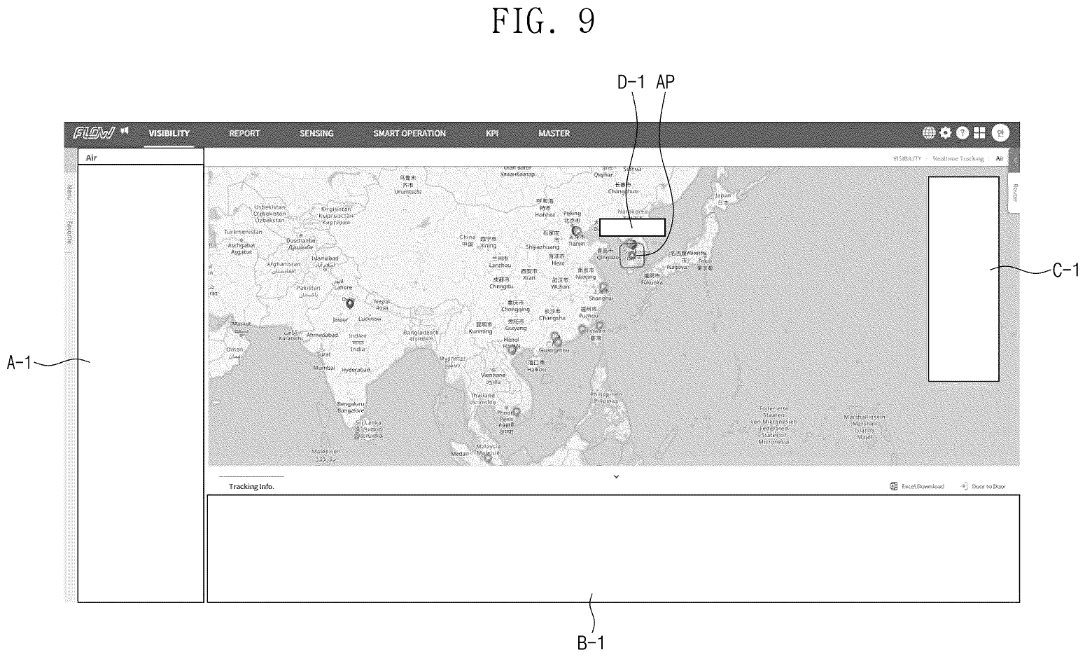

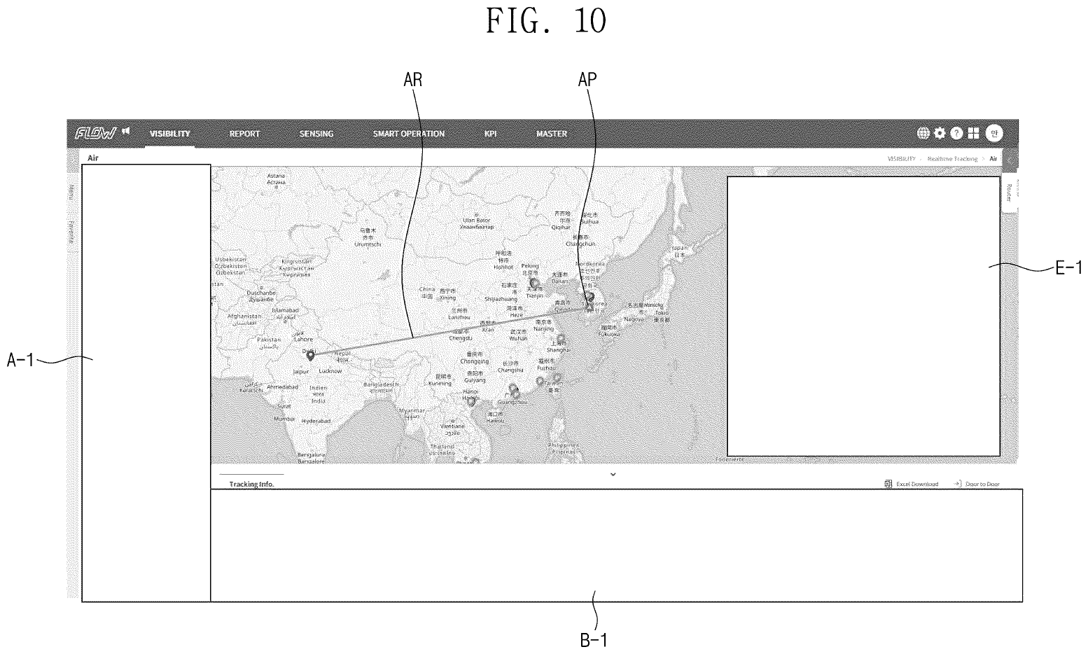

FIGS. 9 and 10 are diagrams showing screens for flight information of an aircraft, which may be capable of being displayed on a goods-owner terminal, according to an operation of a transportation tracking server.

In FIGS. 9 and 10, various information lists displayed around a map may be redacted for security reasons. Hereinafter, information displayed in blocks A-1 to E-1 will be briefly described in the detailed description.

Referring to FIG. 9, an aircraft AP carrying cargo of an owner of goods may be displayed on a map and may be visually provided to the owner of goods. Information about the starting point and destination of an aircraft may be displayed in block A-1 on the left side of the map and may be visually provided to the owner of goods.

The aircraft's flight number, information about a list of cargo loaded onto the aircraft, and whether the aircraft may be delayed may be displayed in block B-1 at the bottom of the map and may be visually provided to the owner of goods. Pieces of risk information may be displayed in block C-1 on the right side of the map and may be visually provided to the owner of goods. The flight number for the aircraft AP (shown in a square box) carrying the cargo of the owner of goods may be displayed in block D-1.

Referring to FIG. 10, a flight route AR of the aircraft may be displayed by clicking the aircraft AP, and may be visually provided to the owner of goods. Also, as detailed information about the aircraft, the starting point, departure time, destination, arrival time, and whether the cargo has been completely transported may be displayed in block E-1 on the right of the map and may be visually provided to the owner of goods.

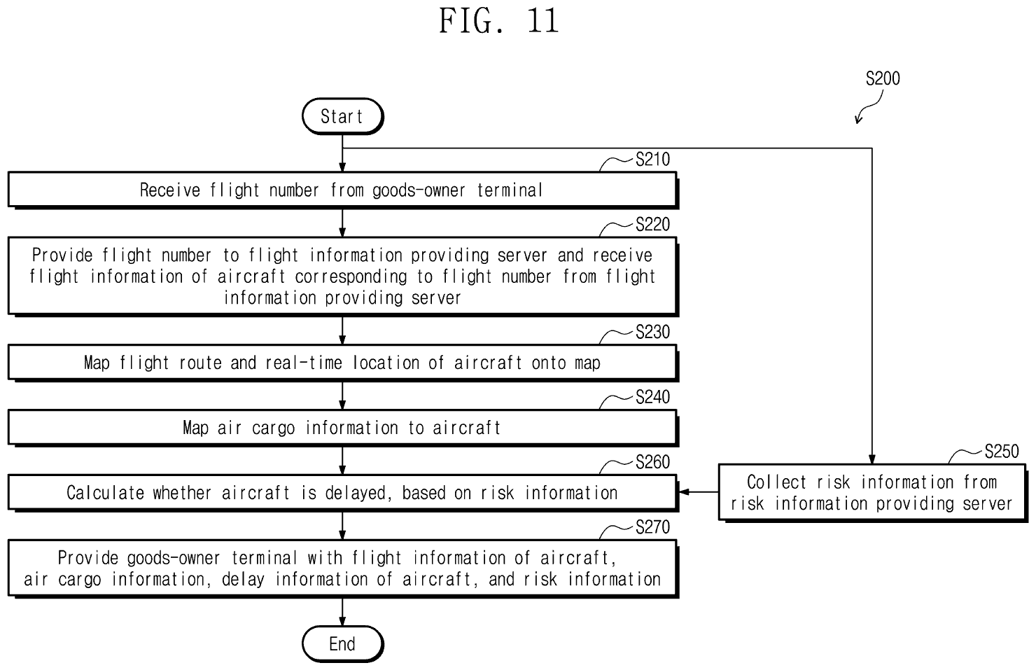

FIG. 11 is a flowchart for describing an operation of a flight tracking server shown in FIG. 8.

Referring to FIGS. 8 and 11, the flight tracking server 120 may process transportation information about an aircraft and may provide the goods-owner terminal 10 with the processed transportation information. For this operation, operation S200 of processing transportation information about an aircraft may include operations S210 to S270 shown in FIG. 11.

In operation S210, the flight tracking server 120 may receive a flight number from the goods-owner terminal 10. In operation S220, the flight tracking server 120 may provide the flight number to the flight information providing server 80 and may receive flight information of an aircraft corresponding to the flight number from the flight information providing server 80.

In operation S230, the flight tracking server 120 may map the flight route and real-time location of the aircraft onto a map. In operation S240, the flight tracking server 120 may map air cargo information to the aircraft.

Operation S250 may be substantially the same as operation S150 described in FIG. 7. In operation S260, the flight tracking server 120 may calculate whether the aircraft may be delayed based on risk information.

In operation S270, the flight tracking server 120 may provide the goods-owner terminal 10 with flight information of the aircraft, air cargo information, delay information of the aircraft, and risk information.

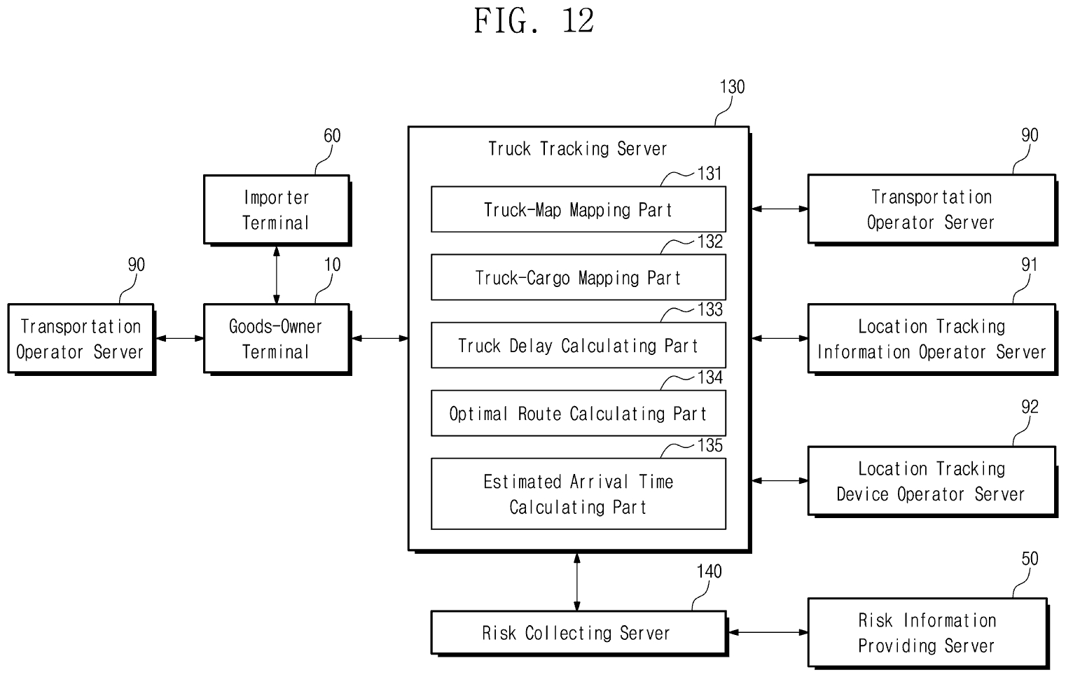

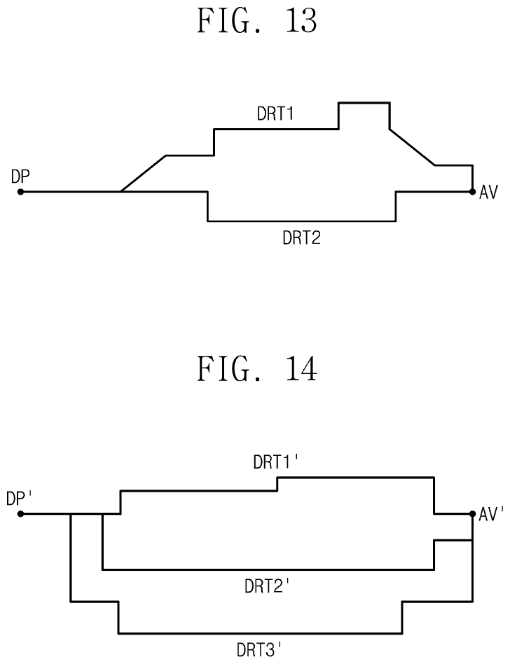

FIG. 12 is a block diagram of a truck tracking server shown in FIG. 2. FIGS. 13 and 14 are diagrams showing routes to a starting point and destination of a truck.

Hereinafter, in FIG. 12, a tracking operation for a truck, onto which cargo may be loaded, is described.

Referring to FIG. 12, the goods-owner terminal 10 may receive truck identification information of a truck for loading cargo of an owner of goods from a transportation operator server 90. The truck identification information may be defined as the truck's unique serial number.

The goods-owner terminal 10 may provide truck identification information to the truck tracking server 130. The truck tracking server 130 may obtain driving information of a truck, on which the cargo of the owner of goods may be loaded, by using the truck identification information.

The truck tracking server 130 may include a truck-map mapping part 131, a truck-cargo mapping part 132, a truck delay calculating part 133, an optimal route calculating part 134, and an estimated arrival time calculating part 135.

The truck-map mapping part 131 may receive and store truck identification information from the goods-owner terminal 10. The truck-map mapping part 131 may provide the truck identification information to the transportation operator server 90 and may receive driving information of the truck corresponding to the truck identification information from the transportation operator server 90. The transportation operator server 90 may be defined as a server of a business operator that provides a cargo transportation service through trucks.

The driving information of a truck may include information such as the truck's driving route, the truck's real-time location, the truck's current speed, the truck's starting point, the truck's destination, and the truck's travel distance. The truck-map mapping part 131 may map pieces of information such as the truck's driving route, the truck's real-time location, the truck's current speed, the truck's starting point, the truck's destination, and the truck's travel distance onto a map. The truck-map mapping part 131 may map the truck's driving information onto the map and may provide the goods-owner terminal 10 with the mapped result. The owner of goods may identify driving information of the truck carrying the cargo through the goods-owner terminal 10.

The truck-cargo mapping part 132 may map truck cargo information onto the truck. The truck cargo information may be defined as information about cargo of the owner of goods, which may be loaded on the truck. The truck cargo information may also be mapped and provided to the goods-owner terminal 10. For example, the truck-map mapping part 131 may map the driving information of the truck, onto which the truck cargo information may be mapped, onto the map and may provide the goods-owner terminal 10 with the mapped result. Accordingly, the owner of goods may identify the truck cargo information and the truck onto which the cargo of the owner of goods may be loaded.

The truck delay calculating part 133 may receive risk information from the risk collecting server 140 and may calculate whether the truck may be delayed based on the risk information. The truck delay calculating part 133 may receive the risk information corresponding to the truck's driving route by making a request for the risk information to the risk information providing server 50. The truck delay calculating part 133 may determine whether the risk information may be capable of affecting an operation of the truck.

For example, in case that driving on a specified route is impossible due to heavy rain, landslides, forest fires, earthquakes, or floods, the truck may need to detour to another road, and thus the arrival of the truck may be delayed. The truck delay calculating part 133 may determine that the truck may be in a delay state based on this risk information.

Due to a truck driver strike, trucks may be temporarily unavailable. The truck delay calculating part 133 may determine that the truck may be in a delay state based on this risk information.

Depending on political situations in a specific country, trucks may be temporarily unavailable. For example, in case that political situations such as a communist party congress in a specific country occur, the corresponding country may temporarily ban cargo distribution in the surrounding area. The truck delay calculating part 133 may determine that the truck may be in a delay state based on this risk information.

The truck delay calculating part 133 may determine the delay state of the truck based on the risk information. The delay state of the truck and the risk information that affected the delay of the truck may be mapped onto the map and then may be provided to the goods-owner terminal 10. For example, the truck-map mapping part 131 may map the delay state of the truck and the risk information that affected the delay of the truck onto the map and may provide the goods-owner terminal 10 with the mapped result.

The owner of goods may identify the delay state of the truck, onto which cargo of the owner of goods may be loaded, and risk information that affected the delay of the truck through the goods-owner terminal 10. The owner of goods may provide the truck's delay information to the importer terminal 60 through the goods-owner terminal 10.

Additionally, in case that the truck stays at another point for a long period of time while significantly deviating from a normal driving route, or significantly slows down, the truck delay calculating part 133 may recognize abnormal situations such as truck hijacking. These abnormal situations may also be mapped to the map by the truck-map mapping part 131 and may be provided to the goods-owner terminal 10.

The cargo may be exported to a specific country and may be transported locally by truck. However, the specific country may prohibit sending GPS information overseas for security reasons. The truck location information of the transportation operator server 90 may be GPS information mounted on the truck.

As a supplementary means for collecting the truck location information, the truck-map mapping part 131 may further obtain real-time location information of the truck through other servers in addition to the transportation operator server 90. For example, the truck-map mapping part 131 may further receive real-time location information of the truck from a location tracking information operator server 91 and a location tracking device operator server 92.

A location tracking information operator may provide (e.g., sell) a location tracking application to a transportation business operator. A driver of the truck carrying cargo may execute the location tracking application on his/her terminal while driving the truck. This operation may be defined as an operation in which the location tracking application matches the truck. The real-time location information of the truck obtained from the location tracking application by executing the location tracking application may be stored in the location tracking information operator server 91.

The truck-map mapping part 131 may provide the truck identification information to the location tracking information operator server 91 and may receive the real-time location of the truck corresponding to the truck identification information from the location tracking information operator server 91. The location tracking information operator server 91 may obtain the truck identification information from the transportation operator server 90.

The location tracking device business operator may provide (e.g., sell) a location tracking device to the transportation business operator. The location tracking device may be mounted on a truck carrying cargo. This operation may be defined as an operation in which the location tracking device matches the truck. The location tracking device may be defined as an IoT location tracker. The real-time location information of the truck obtained from the location tracking device may be stored in the location tracking device operator server 92.

The truck-map mapping part 131 may provide the truck identification information to the location tracking device operator server 92 and may receive the real-time location of the truck corresponding to the truck identification information from the location tracking device operator server 92. The location tracking device operator server 92 may obtain the truck identification information from the transportation operator server 90.

The truck tracking server 130 may further receive various pieces of road information for the truck's driving from the transportation operator server 90. The road information may include not only past information but also information about a new road that may be newly constructed. The transportation operator server 90 may continuously update this road information and may provide the truck tracking server 130 with the updated road information. The road information may be stored in a storage part (not shown) inside the truck tracking server 130.

The optimal route calculating part 134 may calculate an optimal route by using the road information. For example, there may be various routes from a starting point to a destination of the truck. The optimal route calculating part 134 may calculate the shortest route from the starting point to the destination as an optimal route based on the road information about the truck's starting point and destination.

Referring to FIGS. 12 and 13, there may be two routes DRT1 and DRT2 from a starting point DP of the truck to a destination AV of the truck. A distance of the second route DRT2 may be smaller than a distance of the first route DRT1. The optimal route calculating part 134 may calculate the second route DRT2 as the optimal distance.

Referring to FIGS. 12 and 14, there may be three routes DRT1′, DRT2′, and DRT3′ from a starting point DP′ of the truck to the destination AV′ of the truck. The second route DRT2′ may be smaller than the first route DRT1′. The first route DRT1′ may be smaller than the third route DRT3′. A distance of the second route DRT2′ may be the smallest and a distance of the third route DRT3′ may be the greatest.

The optimal route calculating part 134 may check whether a distance difference between routes falls in an error range (e.g., a predetermined or selectable error range). For example, the difference between the distance of the first route DRT1′ and the distance of the second route DRT2′ may be in 1% of the distance of the second route DRT2′. A range in 1% may be defined as an error range (e.g., a predetermined or selectable error range). The error range may be set based on the shortest distance among driving routes. Values in the error range may be examples and may be set in various ways.

The distance of the third route DRT3′ may be outside the error range. A difference between the distance of the third route DRT3′ and the distance of the second route DRT2′ may be greater than 2% of the distance of the second route DRT2′.

The optimal route calculating part 134 may calculate the first route DRT1′ and the second route DRT2′ as the shortest routes, by determining that the distance of the first route DRT1′ may be similar to the distance of the second route DRT2′. In other words, multiple shortest routes may be calculated.

An average altitude of the first route DRT1′ may be higher than an average altitude of the second route DRT2′. As the altitude increases, fuel efficiency of the truck may decrease and carbon emissions of the truck may increase. The optimal route calculating part 134 may calculate the second route DRT2′ of at a low altitude as an optimal route.

The calculated optimal route may be provided to the goods-owner terminal 10. For example, the calculated optimal route may be mapped onto the map by the truck-map mapping part 131, and may be provided to the owner of goods through the goods-owner terminal 10 at the request of the owner of goods.

Operation routes of vessels and aircraft may be determined in general. However, unlike air and sea, there may be various roads on land, and thus a driving route of a truck may be determined in various ways depending on a driver's choice. Even in case that a new road capable of reducing a driving distance is updated, a driver of the truck may drive on the existing route. Accordingly, with reference to the calculated optimal route, the owner of goods may request a transportation business operator to change a driving route of the truck.

Referring to FIG. 12, the estimated arrival time calculating part 135 may calculate the estimated arrival time of the truck based on past driving records corresponding to the driving route of the truck. For example, the estimated arrival time calculating part 135 may calculate the estimated arrival time based on past driving records by using the average speed of trucks driving on the corresponding driving route and a distance of the driving route.

The estimated arrival time thus calculated may be provided to the goods-owner terminal 10. For example, the estimated arrival time thus calculated may be mapped onto the map by the truck-map mapping part 131, and may be provided to the owner of goods through the goods-owner terminal 10 at the request of the owner of goods. Furthermore, the owner of goods may identify the estimated arrival time of the truck with reference to the estimated arrival time thus calculated.

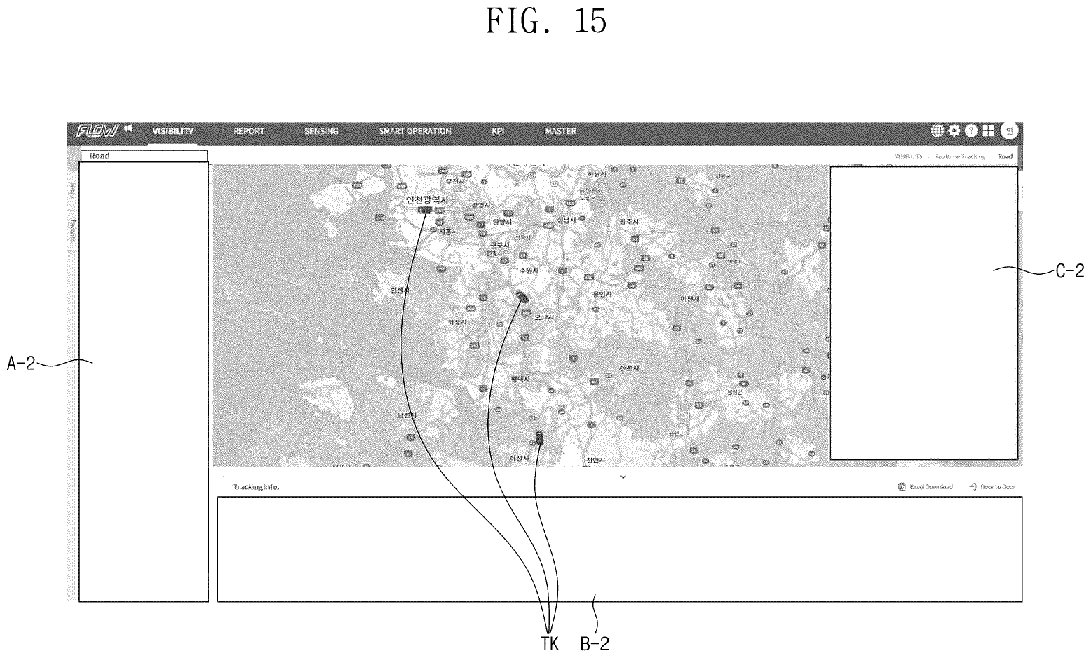

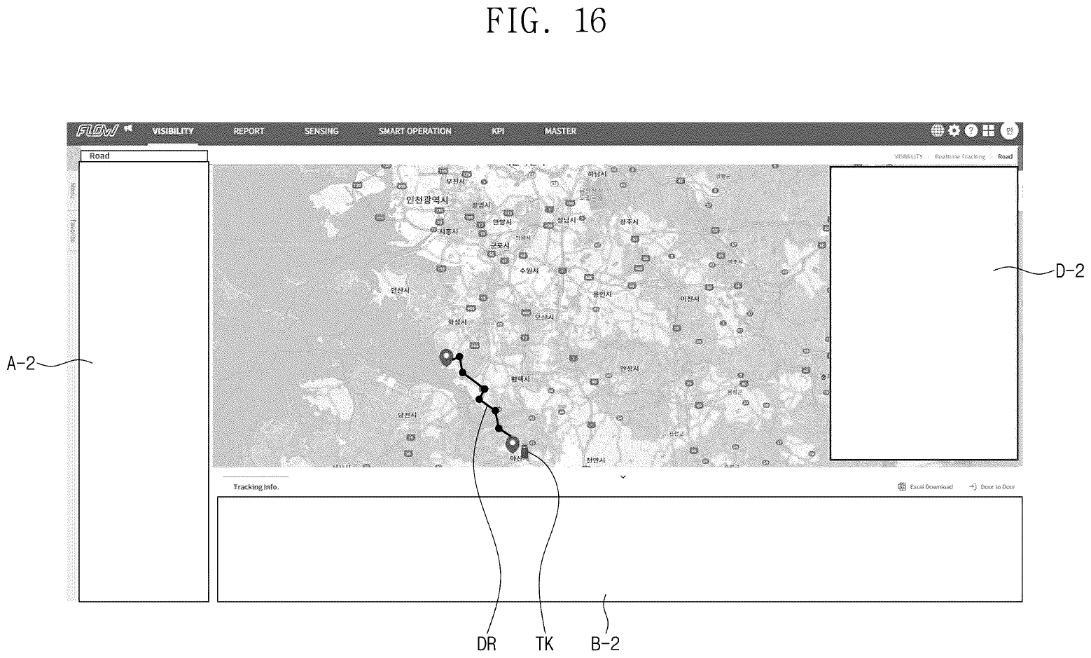

FIGS. 15 and 16 are diagrams showing screens for driving information of a truck, which may be capable of being displayed on a goods-owner terminal, according to an operation of a transportation tracking server.

In FIGS. 15 and 16, various information lists displayed around a map are redacted for security reasons. Hereinafter, information displayed in blocks A-2 to D-2 will be briefly described in the detailed description.

Referring to FIG. 15, real-time locations of trucks TK carrying cargo may be displayed on a map and may be visually provided to an owner of goods. Information about starting points and destinations of trucks may be displayed in block A-2 on the left side of the map and may be visually provided to the owner of goods.

Truck identification information for each truck, pieces of information about a list of cargo loaded on trucks, whether trucks may be delayed, and abnormal situations in trucks may be displayed in block B-2 at the bottom of the map and may be visually provided to the owner of goods. Risk information may be displayed in block C-2 on the right side of the map and may be visually provided to the owner of goods.

Referring to FIG. 16, the driving route of the selected truck may be displayed on the map. Information about a distance for a driving route DR of the selected truck, an arrival time of the selected truck, a speed of the selected truck, and a driver of the selected truck may be displayed in block D-2 on the right side of the map and may be visually provided to the owner of goods. The speed may be provided to the owner of goods for each section indicated with dots on the driving route DR.

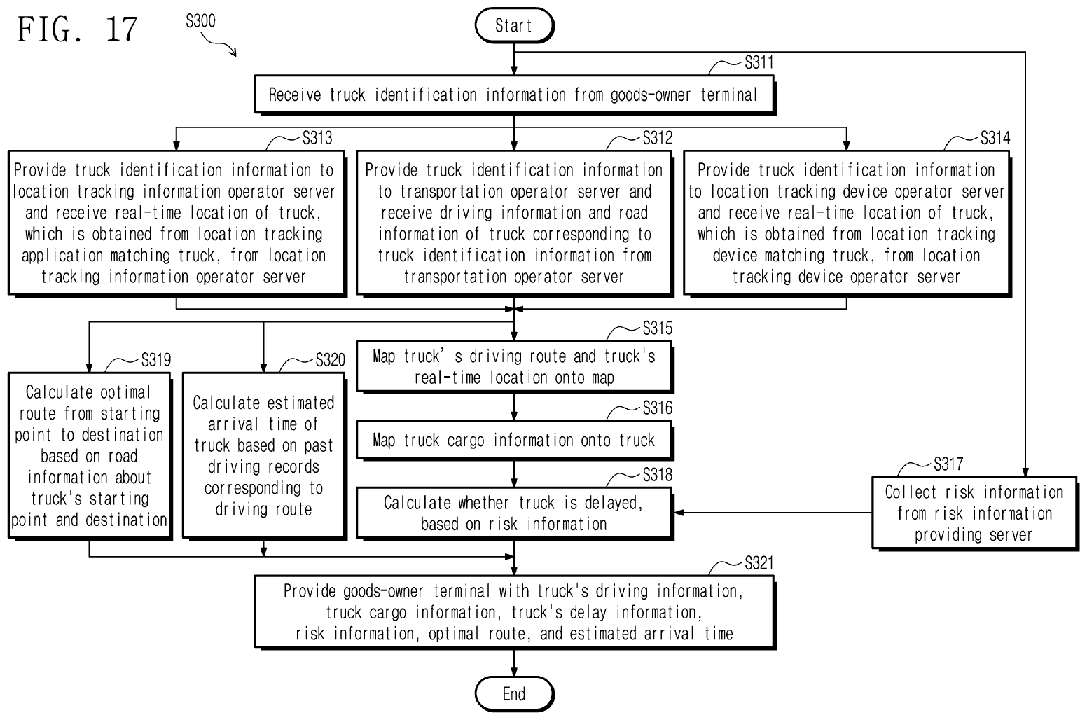

FIG. 17 is a flowchart for describing an operation of a truck tracking server shown in FIG. 12.

Referring to FIGS. 12 and 17, the truck tracking server 130 may process transportation information about a truck and may provide the goods-owner terminal 10 with the processed transportation information. For this operation, operation S300 of processing transportation information about a truck may include operations S311 to S321 shown in FIG. 17.

In operation S311, the truck tracking server 130 may receive truck identification information from the goods-owner terminal 10.

In operation S312, the truck tracking server 130 may provide the truck identification information to the transportation operator server 90 and may receive driving information of a truck corresponding to the truck identification information from the transportation operator server 90.

In operation S313, the truck-map mapping part 131 may provide the truck identification information to the location tracking information operator server 91 and may receive the real-time location of the truck, which may be obtained from a location tracking application matching the truck, from the location tracking information operator server 91.

In operation S314, the truck-map mapping part 131 may provide the truck identification information to the location tracking device operator server 92 and may receive the real-time location of the truck, which may be obtained from a location tracking device matching the truck, from the location tracking device operator server 92.

In an embodiment of the disclosure, operations S312, S313, and S314 may be performed in parallel, but may not be limited thereto. For example, operations S312, S313, and S314 may be performed in serial.

The procedure may proceed to operation S315 after operations S312, S313, and S314. In operation S315, the truck tracking server 130 may map the truck's driving route and the truck's real-time location onto the map. In operation S316, the truck tracking server 130 may map truck cargo information onto the truck.

Operation S317 may be substantially the same as operation S150 described in FIG. 7. In operation S318, the truck tracking server 130 may calculate whether the truck may be delayed based on risk information.

In operation S319, the truck tracking server 130 may calculate an optimal route from the starting point to the destination based on road information about the truck's starting point and destination. As described above, the shortest route from the starting point to the destination may be calculated as the optimal route. In case that multiple shortest routes in an error range (e.g., a predetermined or selectable error range) are calculated, the shortest route at a low altitude may be set as the optimal route. In operation S320, the truck tracking server 130 may calculate the estimated arrival time of the truck based on past driving records corresponding to the driving route.

Operations S315, S319, and S320 may be performed in parallel, but may not be limited thereto. For example, operations S315, S319, and S320 may be performed in serial.

The procedure may proceed to operation S321 after operations S315, S319, and S320. In operation S321, the truck tracking server 130 may provide the goods-owner terminal 10 with the truck's driving information, the truck cargo information, the truck's delay information, the risk information, the truck's optimal route, and the truck's estimated arrival time.

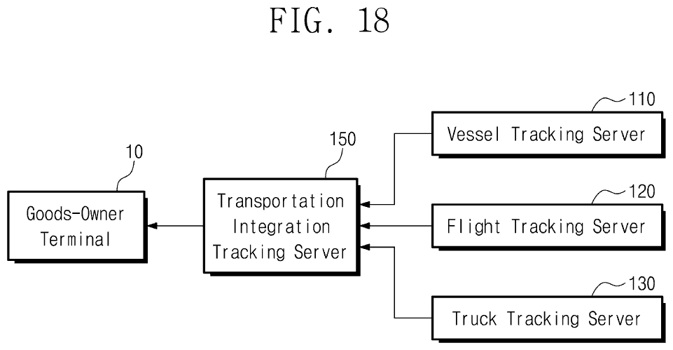

FIG. 18 is a diagram for describing an operation of a transportation integration tracking server shown in FIG. 2.

Referring to FIG. 18, the transportation integration tracking server 150 may receive a vessel's transportation information from the vessel tracking server 110, may receive an aircraft's transportation information from the flight tracking server 120, and may receive a truck's transportation information from the truck tracking server 130.

At the request of the goods-owner terminal 10, the transportation integration tracking server 150 may integrate the transportation information of the vessel, the transportation information of the aircraft, and the transportation information of the truck, and may provide the integrated results to the goods-owner terminal 10. The transportation information of the vessel, the transportation information of the aircraft, and the transportation information of the truck may be integrated and then may be provided to an owner of goods through the goods-owner terminal 10. Accordingly, the owner of goods may readily identify the integrated transportation information.

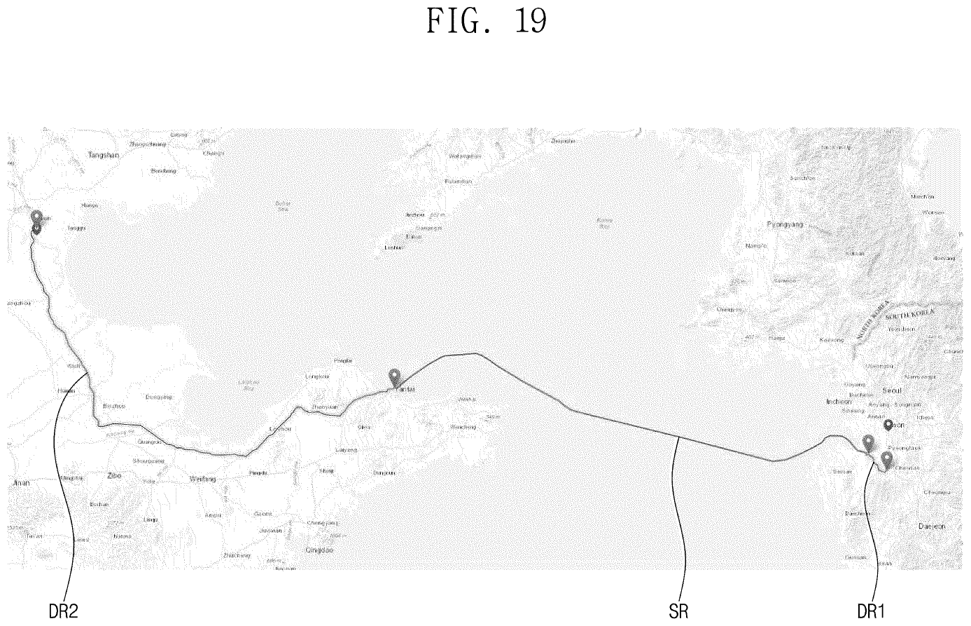

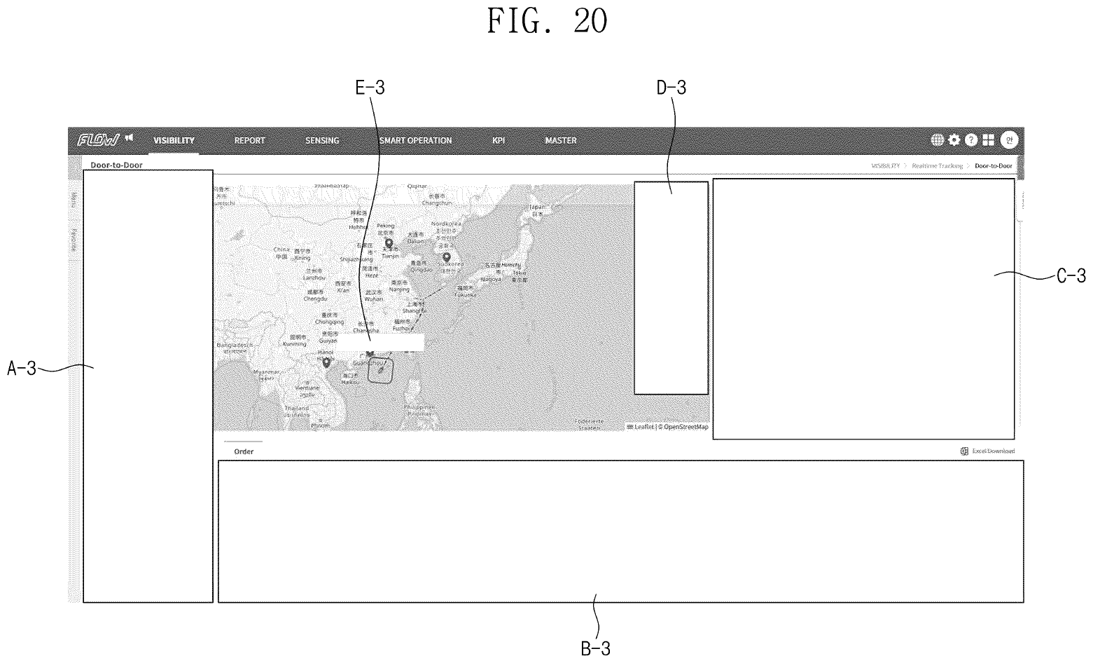

FIGS. 19 and 20 are diagrams showing screens for integrated transportation information capable of being displayed on a goods-owner terminal according to an operation of a transportation integration tracking server.

In FIG. 20, various information lists displayed around a map are redacted for security reasons. Hereinafter, in FIG. 20, information displayed in blocks A-3 to E-3 will be briefly described in the detailed description.

Referring to FIG. 19, an integrated route may be provided to an owner of goods through the goods-owner terminal 10. For example, a route along which cargo may be transported may include a first driving route DR1 transported by truck, a navigation route SR transported by vessel, and a second driving route DR2 transported by truck. The first driving route DR1, the navigation route SR, and the second driving route DR2 may be integrated and then may be visually provided to the owner of goods through the goods-owner terminal 10.

For example, transportation routes of a truck, a vessel, and a truck may be integrated and shown. However, an embodiment may not be limited thereto. For example, various routes may be integrated and shown on a map. For example, depending on transportation, transportation routes of a truck, an air, and a truck may be integrated and shown on the map.

Referring to FIG. 20, a starting point of cargo, a destination of cargo, and the expected arrival date of cargo may be displayed in block A-3 based on the integrated route and may be visually provided to the owner of goods. In FIG. 19, the starting point of cargo may be the starting point of the first driving route DR1, and the destination of cargo may be the destination of the second driving route DR2.

Information (vessel identification information, flight number, truck identification information) about transportation (a vessel, an aircraft, and a truck), information about cargo loaded on transportation, and delay information of transportation may be displayed in block B-3 and provided visually to the owner of goods.

The destination, starting point, and expected arrival date for each transportation (a vessel, an aircraft, and a truck) may be displayed in block C-3 and may be provided visually to the owner of goods. Pieces of risk information may be displayed in block D-3 and may be visually provided to the owner of goods. Besides, the vessel name of the selected vessel may be displayed in block E-3 by selecting a specific vessel (a portion displayed in a square shape).

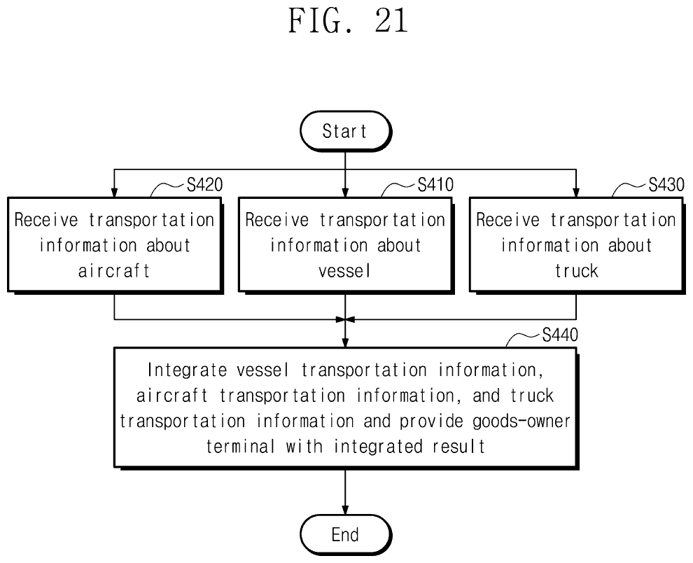

FIG. 21 is a flowchart for describing an operation of a transportation integration tracking server shown in FIG. 18.

Referring to FIG. 21, in operation S410, the transportation integration tracking server 150 may receive transportation information about a vessel. In operation S420, the transportation integration tracking server 150 may receive transportation information about an aircraft. In operation S430, the transportation integration tracking server 150 may receive transportation information about a truck. Operations S410, S420, and S430 may proceed in parallel.

The procedure may proceed to operation S440 after operations S410, S420, and S430. In operation S440, the transportation integration tracking server 150 may integrate vessel transportation information, aircraft transportation information, and truck transportation information and may provide the goods-owner terminal 10 with the integrated result. Accordingly, an owner of goods may identify integrated transportation information through the goods-owner terminal 10.

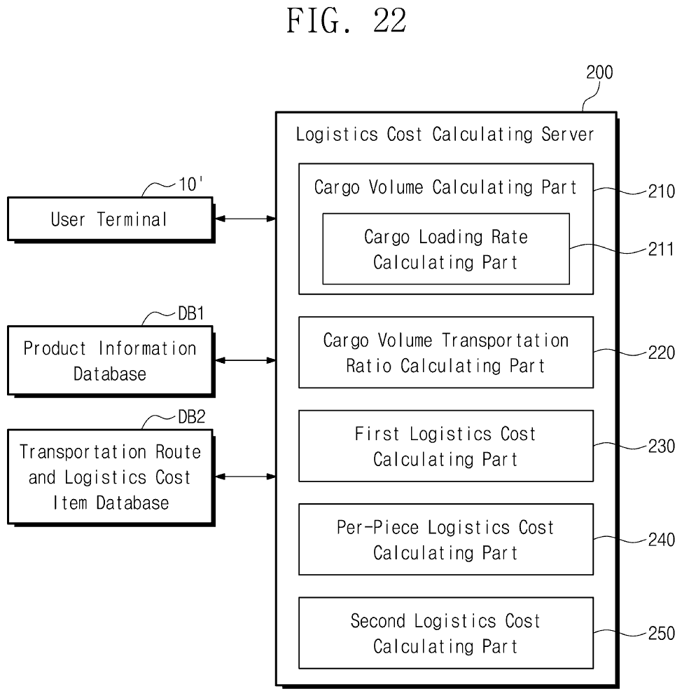

FIG. 22 is a block diagram of a logistics cost calculating server shown in FIG. 1.

Referring to FIG. 22, the logistics cost calculating server 200 may communicate with a user terminal 10′ and may provide information to the user terminal 10′. The above-described goods-owner terminal 10 may include the user terminal 10′. A user may be defined as an administrator who manages the logistics cost calculating server 200 through the user terminal 10′.

The logistics cost calculating server 200 may calculate logistics costs by using data of a product information database DB1 and data of a transportation route and logistics cost item database DB2. Hereinafter, the product information database DB1 may be referred to as the “first database DB1”, and the transportation route and logistics cost item database DB2 may be referred to as the “second database DB2”.

The logistics cost calculating server 200 may include a cargo volume calculating part 210, a cargo volume transportation ratio calculating part 220, a first logistics cost calculating part 230, a per-piece logistics cost calculating part 240, and a second logistics cost calculating part 250.

In this specification, “cargo” may be defined as goods or products, and “cargo volume” may be defined as the amount of products (or cargo) transported or the amount of product (or cargo) moved.

The cargo volume calculating part 210 may calculate the total weight of next year's production products, the number of trucks to load next year's production products, and the number of containers to load next year's production products depending on the number of next year's production products, per-piece weight of next year's production products, and per-piece volume of next year's production products.

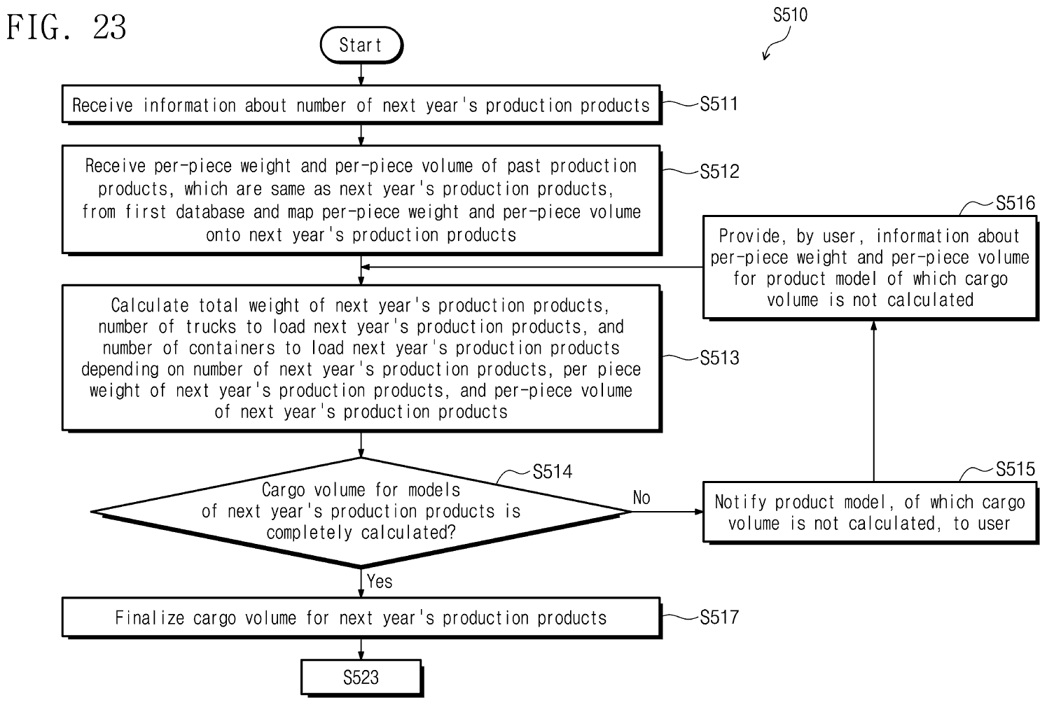

An operation of calculating the total weight of next year's production products, the number of trucks to load next year's production products, and the number of containers to load next year's production products may be defined as an operation of calculating cargo volume. A specific operation of the cargo volume calculating part 210 will be described in detail below with reference to the flowchart of FIG. 23.

The cargo volume calculating part 210 may include a cargo loading rate calculating part 211. The cargo loading rate calculating part 211 may store information about the size of a cargo compartment and the size of a container of trucks used in the past. The cargo loading rate calculating part 211 may calculate the maximum loading quantity of cargo boxes for a truck and container depending on the size of the truck's cargo compartment, the size of the container, a placement direction of standardized cargo boxes to load next year's production products, and loading conditions of the cargo boxes.

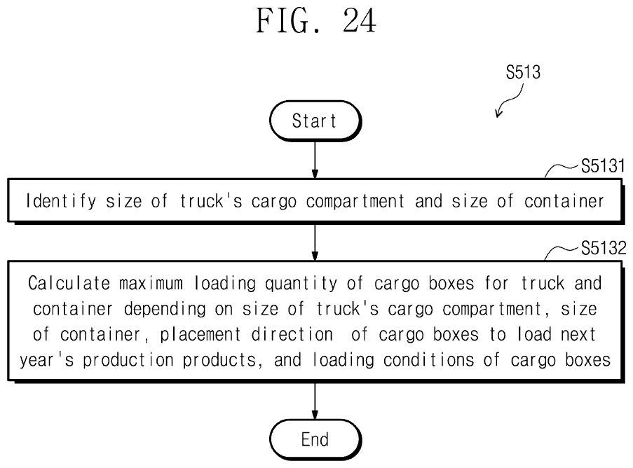

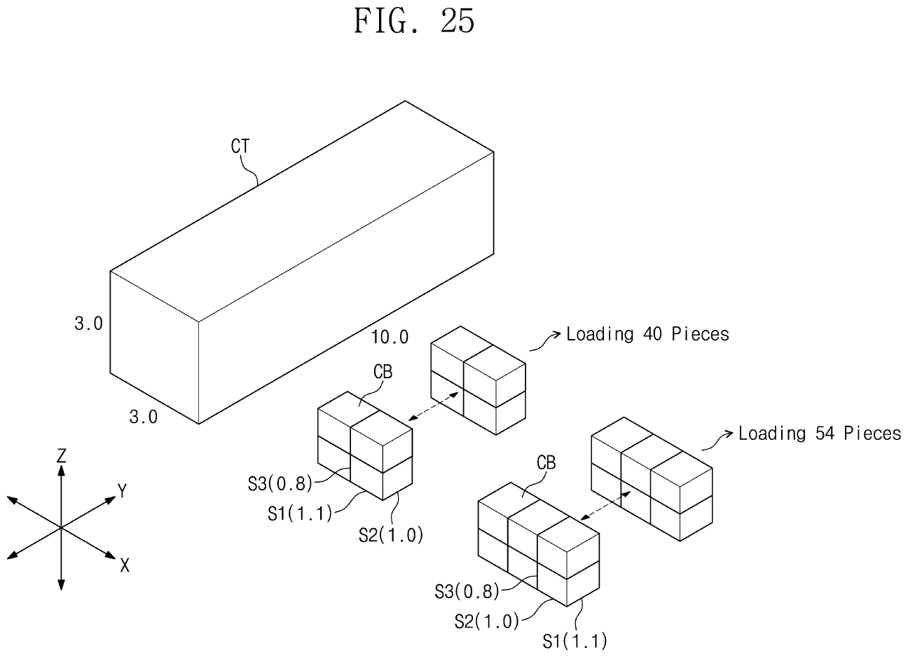

The cargo volume calculating part 210 may calculate the number of trucks to load next year's production products, and the number of containers to load next year's production products, by using the calculation results of the cargo loading rate calculating part 211. A specific operation of the cargo loading rate calculating part 211 will be described in detail below with reference to the flowchart of FIG. 24 and FIG. 25.

The cargo volume transportation ratio calculating part 220 may determine next year's transportation routes and the transportation ratio of the next year's transportation routes based on past transportation routes of past production products corresponding to the next year's production products, and the past transportation ratio of the past transportation routes.

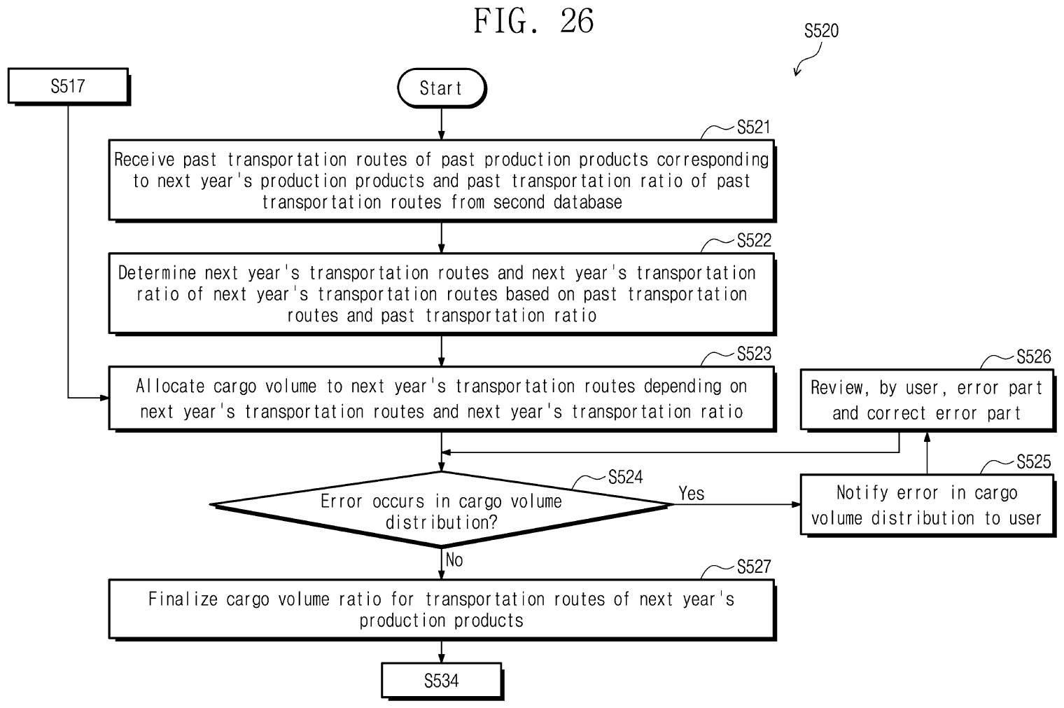

The cargo volume transportation ratio calculating part 220 may allocate the cargo volume calculated by the cargo volume calculating part 210 to the next year's transportation routes depending on the next year's transportation routes and the next year's transportation ratio. A specific operation of the cargo volume transportation ratio calculating part 220 will be described in detail below with reference to the flowchart of FIG. 26 and FIGS. 27 to 28.

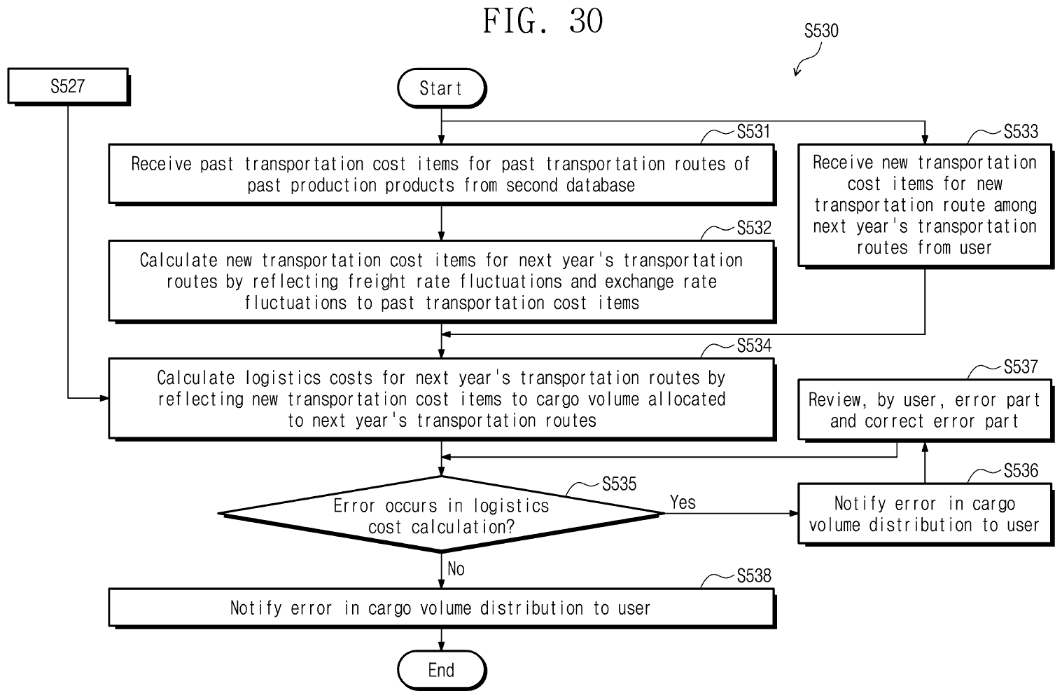

The first logistics cost calculating part 230 may calculate new transportation cost items for next year's transportation routes by reflecting changed freight costs and exchange rate fluctuations to past transportation cost items for the past transportation routes of the past production products. The first logistics cost calculating part 230 may calculate logistics costs for the next year's transportation routes by reflecting the new transportation cost items to the cargo volume allocated to the next year's transportation routes. Hereinafter, a specific operation of the first logistics cost calculating part 230 will be described in detail with reference to the flowchart of FIG. 30.

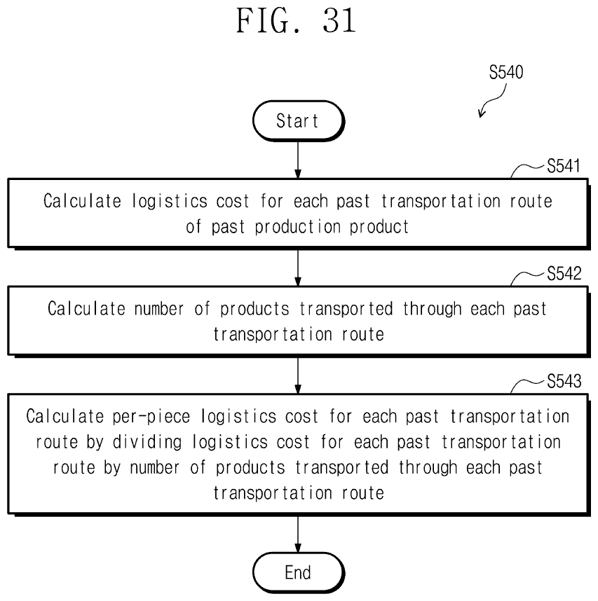

The per-piece logistics cost calculating part 240 may calculate a per-piece logistics cost for each past transportation route by dividing the logistics cost for each past transportation route of a past production product by the number of products transported through each past transportation route. Hereinafter, a specific operation of the per-piece logistics cost calculating part 240 will be described in detail with reference to the flowchart of FIG. 31.

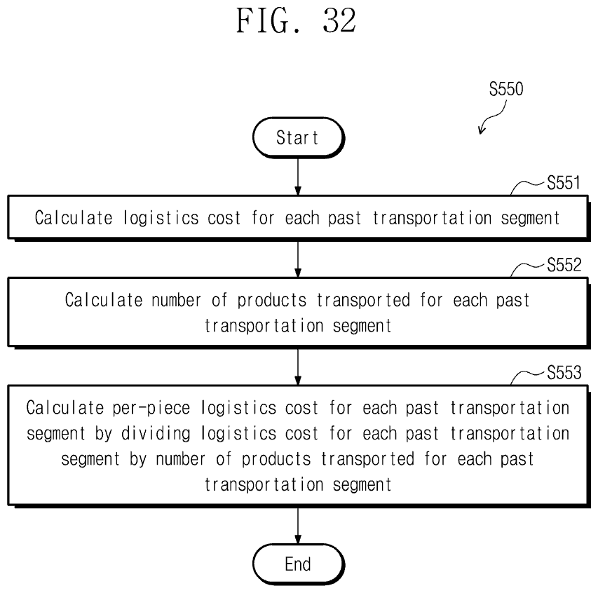

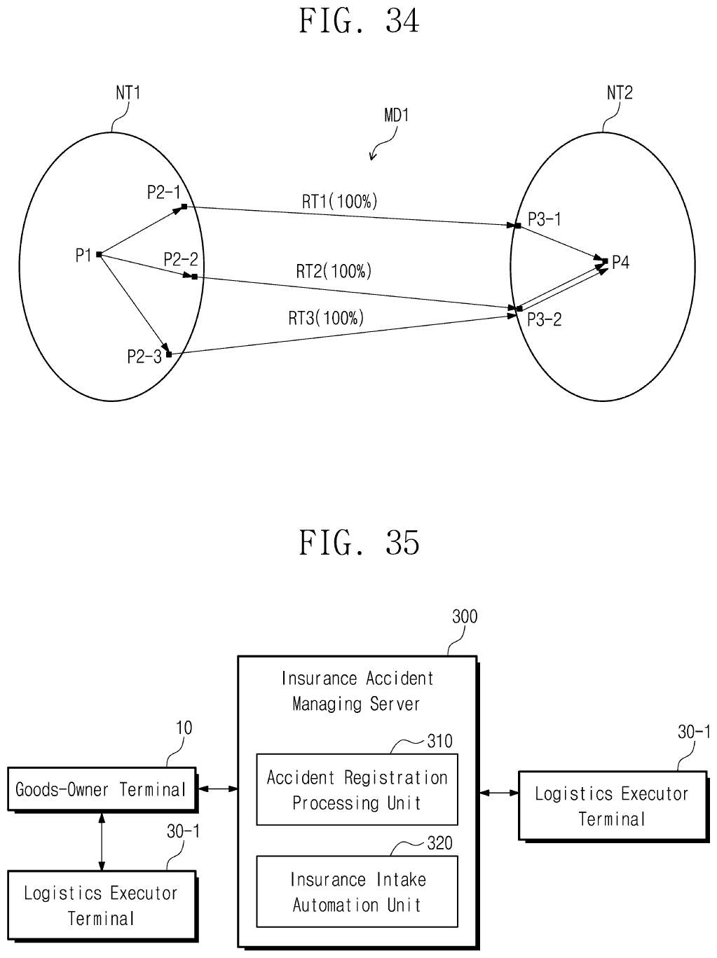

The second logistics cost calculating part 250 may allocate 100% of cargo volume to each of the next year's transportation routes, and may calculate the logistics cost for each of next year's transportation routes by reflecting new transportation cost items to each of the next year's transportation routes. Hereinafter, a specific operation of the second logistics cost calculating part 250 will be described in detail with reference to the flowchart of FIG. 32 and FIG. 34.

FIG. 23 is a flowchart for describing an operation of a cargo volume calculating part shown in FIG. 22.

Referring to FIGS. 22 and 23, an operation in which the logistics cost calculating server 200 calculates logistics costs may include an operation of calculating cargo volume. To this end, operation S510 of calculating cargo volume may include operations S511 to S517 shown in FIG. 23.

In operation S511, the cargo volume calculating part 210 may receive information about the number of next year's production products. The information about the number of next year's production products may be determined and provided by a management department.

In operation S512, the cargo volume calculating part 210 may receive per-piece weight and per-piece volume of past production products, which may be the same as next year's production products, from the first database DB1 and may map the per-piece weight and the per-piece volume onto next year's production products.

For example, information about the per-piece weight and per-piece volume of each past production product may be stored in the first database DB1. The cargo volume calculating part 210 may receive the per-piece weight and per-piece volume of past production products, which may be the same as next year's production products, from the first database DB1 and may identify the per-piece weight and per-piece volume of the next year's production products. As a result, in operation S512, the per-piece weight and the per-piece volume of next year's production products may be determined.

In operation S513, the cargo volume calculating part 210 may calculate the total weight of next year's production products, the number of trucks to load the next year's production products, and the number of containers to load the next year's production products depending on the number of next year's production products, per piece weight of the next year's production products, and per-piece volume of the next year's production products.

For example, the total weight of the next year's production products may be calculated by multiplying the per-piece weight of the next year's production products by the number of next year's production products. Because information about the per-piece volume of the next year's production products may be obtained, the number of products capable of being loaded onto a truck may be calculated depending on the truck's loading capacity. Moreover, the number of products capable of being loaded onto a container may be calculated depending on the container's capacity. As a result, the number of trucks and the number of containers to load next year's production products may be calculated.

In practice, the number of trucks and the number of containers to load next year's production products may be calculated by using a standardized cargo box for loading products. This method will be described in detail below with reference to FIGS. 24 and 25.

In operation S514, the cargo volume calculating part 210 may check whether the cargo volume for models of next year's production products may be completely calculated. For example, the next year's production products may include a first model having a past performance and a second model having no past performance. The second model may actually be a new model to be produced in the next year. Accordingly, information about the per-piece weight and per-piece volume for the second model may not be present in the first database DB1.

As mentioned above, the cargo volume calculating part 210 may receive the per-piece weight and per-piece volume for the first model from the first database DB1, but may not receive the per-piece weight and per-piece volume for the second model from the first database DB1. Because there may be no per-piece weight and per-piece volume for the second model, the cargo volume for models of the next year's production products may not be completely calculated.

In case that the cargo volume for models of the next year's production products is not completely calculated, the procedure may proceed to operation S515. In operation S515, the product model of which the cargo volume may not be calculated may be notified to a user through the user terminal 10′.

In operation S516, the user may identify information about the per-piece weight and per-piece volume for the product model of which the cargo volume may not be calculated, and may provide the identified result to the cargo volume calculating part 210. In other words, the cargo volume calculating part 210 may receive information about the per-piece weight and per-piece volume for the second model from the user. The per-piece weight and per-piece volume for the second model may be entered into the cargo volume calculating part 210 through the user terminal 10′. Accordingly, the procedure may proceed to operation S513 after operation S516, and the cargo volume for the second model may be calculated.

Additionally, the user may also store information about the per-piece weight and per-piece volume for the second model in the first database DB1 through the user terminal 10′.

In case that the cargo volume for models of the next year's production products is completely calculated, the procedure may proceed to operation S517, and the cargo volume for next year's production products may be finalized. Afterwards, the procedure may proceed to operation S523.

FIG. 24 is a flowchart for describing an operation of a cargo loading rate calculating part shown in FIG. 22. FIG. 25 is a diagram for describing a method of calculating a maximum loading rate for a truck or container.

Referring to FIGS. 24 and 25, in operation S5131, the cargo loading rate calculating part 211 may identify a size of a truck's cargo compartment and a size of a container. This size information may be stored in a storage part (not shown) in the cargo loading rate calculating part 211. The cargo compartment of a truck may be defined as a closed cargo compartment (a box-type cargo compartment) of a box truck.

FIG. 25 shows a container box CT for accommodating cargo. The container box CT may be a container capable of being loaded onto the cargo compartment of a truck or a vessel. The size of the truck's cargo compartment may vary. For example, the size of the cargo compartment used for a 10-ton truck may be different from the size of the cargo compartment used for a 20-ton truck. The size of the cargo compartment used in a truck may be different from the size of the container.

The sizes of the container box CT may be 3 m by 10 m by and 3 m in directions X, Y, and Z, respectively. Direction X may intersect direction Y. Direction Z may perpendicularly intersect a plane defined by direction X and direction Y. The size of the container box CT may be shown as an example, but may not be limited to an embodiment of FIG. 25. For example, the container box CT may have various sizes.

In operation S5132, the cargo loading rate calculating part 211 may calculate the maximum loading quantity of cargo boxes for a truck and container depending on the size of the truck's cargo compartment, the size of the container, a placement direction of standardized cargo boxes CB to load next year's production products, and loading conditions of the cargo boxes CB.

For example, the cargo box CB may have a hexahedral shape. The bottom surface of the cargo box CB may include a first side S1 and a second side S2 that form a right angle. The first side S1 may have a length of 1.1 m, and the second side S2 may have a length of 1.0 m. The cargo box CB may include a third side S3 extending in direction Z. The third side S3 may have a length of 0.8 m.

The number (e.g., predetermined or selectable number) of products may be contained in the cargo box CB. Information about volume per product described above may include information about the horizontal length, vertical length, and thickness of the product. Accordingly, the number of products capable of being contained in the cargo box CB may be determined. In case that the number of next year's production products is 1000 and the cargo box CB is capable of containing 10 products, a total of 100 cargo boxes CB may be required.

In case that the cargo boxes CB are stacked on each other to exceed two stages, products in the cargo box CB placed in the first stage may be damaged depending on the load. Accordingly, the cargo boxes CB need to be stacked on each other not to exceed two stages. This may be a loading condition of the cargo box CB and may be entered into the cargo loading rate calculating part 211 through the user terminal 10′.

In case that the first side S1 is placed to be parallel to direction X and the second side S2 is placed to be parallel to direction Y, a total of 40 cargo boxes CB may be loaded into the container box CT. In case that the second side S2 is placed to be parallel to direction X and the first side S1 is placed to be parallel to direction Y, a total of 54 cargo boxes CB may be loaded into the container box CT.

The cargo loading rate calculating part 211 may calculate the maximum loading quantity at a point in time in case that the 54 cargo boxes CB are loaded into the container box CT. Accordingly, in case that the number of next year's production products is 1000 and a total of 100 cargo boxes CB are required to contain the next year's production products, the cargo volume calculating part 210 may calculate the number of container boxes CT for loading the next year's production product as two.

On the basis of the calculation results of the cargo loading rate calculating part 211, the cargo volume calculating part 210 may calculate the number of trucks for loading the next year's production product and the number of containers for loading the next year's production product.

In case that the container box CT is a cargo compartment of a truck, the number of trucks for loading next year's production products may be calculated as two. In case that the container box CT is a container, the number of containers for loading the next year's production products may be calculated as two.

Depending on the weight of the truck, the size of the cargo compartment may be set in various ways. For example, the size of the cargo compartment used in a 10-ton truck may be smaller than the cargo compartment used in a 20-ton truck. Accordingly, the maximum loading quantity for a 10-ton truck and the maximum loading quantity for a 20-ton truck may be calculated differently from each other. As a result, the number of 10-ton trucks to load the next year's production product and the number of 20-ton trucks to load the next year's production product may be calculated differently from each other.

The number of trucks for loading the next year's production products may be calculated for each truck type. For example, the cargo volume calculating part 210 may individually calculate the number of 10-ton trucks for loading next year's production products and the number of 20-ton trucks for loading next year's production products.

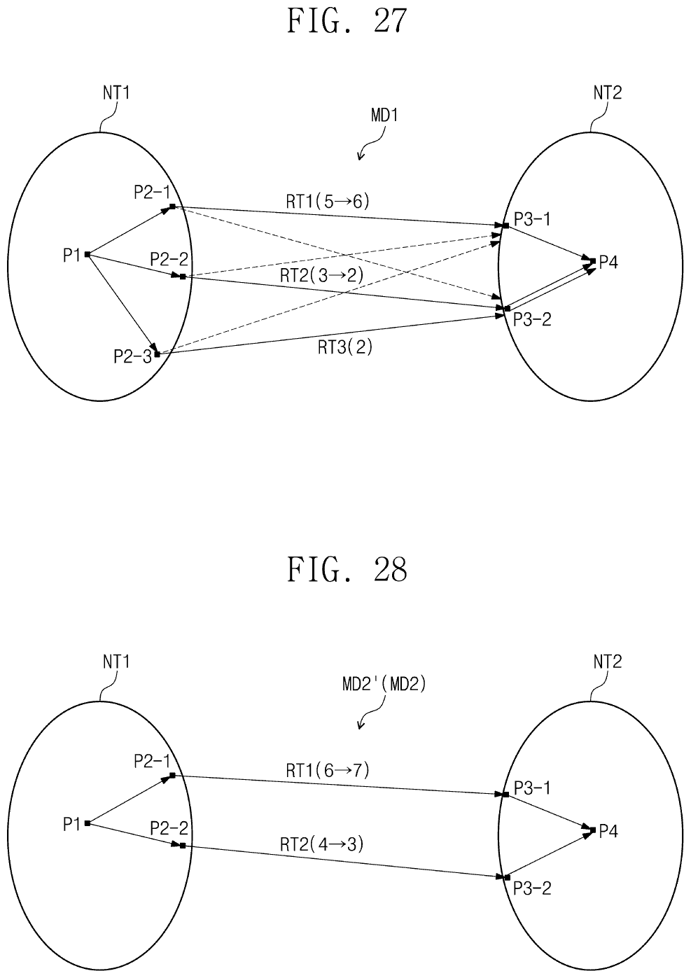

FIG. 26 is a flowchart for describing an operation of a cargo volume transportation ratio calculating part for each route shown in FIG. 22. FIGS. 27 to 29 are diagrams showing various routes through which products may be transported.

Referring to FIG. 26, an operation in which the logistics cost calculating server 200 calculates logistics costs may include an operation of calculating a cargo volume transportation ratio. To this end, operation S520 of calculating a cargo volume transportation ratio may include operations S521 to S527 shown in FIG. 26.

Information about past transportation routes for past production products and a past transportation ratio of the past transportation routes may be stored in the second database DB2.

In operation S521, the cargo volume transportation ratio calculating part 220 may receive, from the second database DB2, the past transportation routes of past production products corresponding to the next year's production products and the past transportation ratio of the past transportation routes. For example, the past transportation routes and the past transportation ratios may be data collected for one year from now. However, an embodiment may not be limited thereto. Depending on the user's settings, data collected for 2, 3, or 5 years may be statistically calculated, and then may be provided to the cargo volume transportation ratio calculating part 220 as the past transportation routes and the past transportation ratio.

According to the above-described example, the first model of next year's production products may have a past performance, and the second model of next year's production products may not have a past performance.

In the case of the first model, the cargo volume transportation ratio calculating part 220 may receive the past transportation routes and the past transportation ratio for the first model from the second database DB2. For example, as a model of a panel used in a mobile phone, the first model may be a model of the panel produced in the last year and may be selected as a product to be produced in this year. Accordingly, in case of the first model, the transportation routes and transportation ratio for the first model of the panel produced in the last year may be provided to the cargo volume transportation ratio calculating part 220.

Information about the same product model as the second model of the next year's production product may not be present in the second database DB2. The cargo volume transportation ratio calculating part 220 may receive the past transportation routes and past transportation ratio of the same product family as the second model from the second database DB2.

For example, the second model may be a model of a panel used in a notebook computer. Moreover, the second model may be a next year's new panel used in a notebook computer. The past transportation routes for panels of notebook computers produced in the last year and the past transportation ratio of the past transportation routes may be provided to the cargo volume transportation ratio calculating part 220.

The past transportation routes for the first model are shown in FIG. 27. The past transportation routes of the same product family as the second model are shown in FIG. 28.

Referring to FIG. 27, a first model MD1 may have been transported from a first point P1 to a fourth point P4 through various transportation routes. The first point P1 may be a starting point, and the fourth point P4 may be a destination. The first model MD1 has been transported from the first point P1 to three second points P2-1, P2-2, and P2-3 along a transportation segment (or transportation leg), has been transported from the second points P2-1, P2-2, and P2-3 to the two third points P3-1 and P3-2 along another transportation segment, and has been transported from the third points P3-1 and P3-2 to the fourth point P4 along yet another transportation segment.

Depending on the number of second points P2-1, P2-2, and P2-3 and the number of third points P3-1 and P3-2, there may be a total of six transportation routes (shown by dotted and solid arrows). However, for convenience of description, assuming that the first model MD1 may be transported on three transportation routes shown by solid arrows, an embodiment of the disclosure will be described below.

The first model MD1 may have been transported via a first route RT1, a second route RT2, and a third route RT3. The first route RT1 may be formed as a route from connecting the first point P1, the second point P2-1, the third point P3-1, and the fourth point P4. The second route RT2 may be formed as a route from connecting the first point P1, the second point P2-2, the third point P3-2, and the fourth point P4. The third route RT3 may be formed as a route from connecting the first point P1, the second point P2-3, the third point P3-2, and the fourth point P4.

Modes of transportation of the first route RT1, the second route RT2, and the third route RT3 may vary. For example, in case of the first route RT1, a truck used from the first point P1 to the second point P2-1, a vessel used from the second point P2-1 to the third point P3-1, a truck used from the third point P3-1 to the fourth point P4 may have been used.

In case of the second route RT2, a truck used from the first point P1 to the second point P2-2, an aircraft used from the second point P2-2 to the third point P3-2, a truck used from the third point P3-2 to the fourth point P4 may have been used.

In case of the third route RT3, an aircraft used from the first point P1 to the second point P2-3, a vessel used from the second point P2-3 to the third point P3-2, a truck used from the third point P3-2 to the fourth point P4 may have been used.

The first model MD1 may have been allocated to the first route RT1, the second route RT2, and the third route RT3 in a ratio of “5:3:2” and then may be transported. For example, in case that 1000 products of the first model MD1 may be transported, 500 products of the first model MD1 may have been transported via the first route RT1, 300 products of the first model MD1 may have been transported via the second route RT2, and 200 products of the first model MD1 may have been transported via the third route RT3. For example, in FIG. 27, the number on the left among numbers in parentheses may be a past transportation ratio.

Referring to FIG. 28, transportation routes for the same product family MD2′ as a second model MD2 may also vary. The first route RT1 for the same product family MD2′ and the second route RT2 for the same product family MD2′ may be shown. However, an embodiment may not be limited thereto. For example, the route for the same product family MD2′ may be set as a different route. The same product family MD2′ may have been allocated to the first route RT1 and the second route RT2 in a ratio of “6:4” and then may be transported. For example, in FIG. 28, the number on the left among numbers in parentheses may be a past transportation ratio.

Referring to FIG. 26, in operation S522, the cargo volume transportation ratio calculating part 220 may determine the next year's transportation routes and the next year's transportation ratio of the next year's transportation routes based on past transportation routes and a past transportation ratio. The next year's transportation routes and the next year's transportation ratio may be the next year's transportation routes of the next year's production products and the next year's transportation ratio of the next year's transportation routes.

Referring to FIGS. 26 and 27, the cargo volume transportation ratio calculating part 220 may determine the next year's transportation routes for the first model MD1 and the next year's transportation ratio by using the past transportation routes of the first model MD1 and the past transportation ratio.

For example, the first, second, and third routes RT1, RT2, and RT3 may be set as the first, second, and third routes RT1, RT2, and RT3 in the next year. According to changes in transportation plans, the past transportation ratio for the first, second, and third routes RT1, RT2, and RT3 has been “5:3:2”. However, the transportation ratio for the first, second, and third routes RT1, RT2, and RT3 in the next year may be changed to “6:2:2”. For example, in FIG. 27, the number on the right among numbers in parentheses may be the next year's transportation ratio.

The cargo volume transportation ratio calculating part 220 may receive the changed transportation ratio through a user. For example, the user may enter the changed transportation ratio into the cargo volume transportation ratio calculating part 220 through the user terminal 10′. The cargo volume transportation ratio calculating part 220 may reflect the changed transportation ratio to the first, second, and third routes RT1, RT2, and RT3.

Referring to FIGS. 26 and 28, the cargo volume transportation ratio calculating part 220 may determine the next year's transportation routes and next year's transportation ratio for the second model MD2 by using the past transportation routes and past transportation ratio of the same product family MD2′ as the second model MD2.

For example, the first and second routes RT1 and RT2 of the same product family MD2′ may be set as the first and second routes RT1 and RT2 of the second model MD2 in the next year. According to changes in transportation plans, the past transportation ratio for the first and second routes RT1 and RT2 has been “6:4”. However, the transportation ratio for the first and second routes RT1 and RT2 in the next year may be changed to “7:3”. For example, in FIG. 28, the number on the right among numbers in parentheses may be the next year's transportation ratio.

For example, the changed transportation ratio may be entered into the cargo volume transportation ratio calculating part 220 through the user terminal 10′. The cargo volume transportation ratio calculating part 220 may reflect the changed transportation ratio to the first and second routes RT1 and RT2.

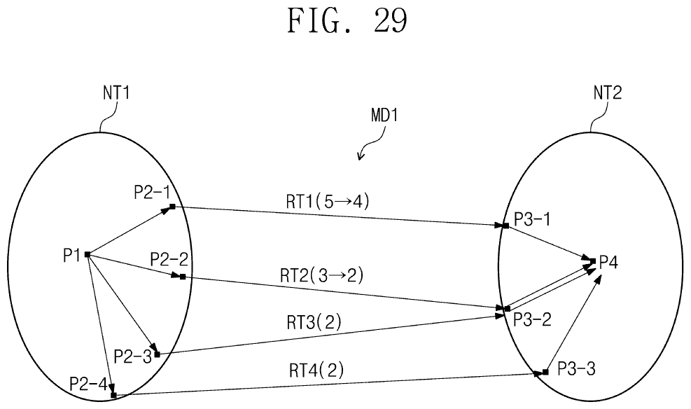

Referring to FIGS. 26 and 29, in case that determining the next year's transportation routes based on the past transportation routes, the cargo volume transportation ratio calculating part 220 may add a new transportation route. For example, in addition to the first, second, and third routes RT1, RT2, and RT3, a fourth route RT4, which may be a new transportation route, may be added as the next year's transportation route for the first model MD1. The fourth route RT4 may be formed as a route from connecting the first point P1, a second point P2-4, a third point P3-3, and the fourth point P4.

Furthermore, in case that determining the next year's transportation ratio based on the past transportation ratio, the cargo volume transportation ratio calculating part 220 may determine a ratio for a new route. For example, the past transportation ratio for the first, second, and third routes RT1, RT2, and RT3 has been “5:3:2”. However, the transportation ratio for the first, second, third, and fourth routes RT1, RT2, RT3, and RT4 in the next year may be changed to “4:2:2:2”.

The cargo volume transportation ratio calculating part 220 may receive the added transportation route and the transportation ratio, which may be changed depending on the added transportation route, from the user. For example, the user may enter the added transportation route and the new transportation ratio into the cargo volume transportation ratio calculating part 220 through the user terminal 10′. The cargo volume transportation ratio calculating part 220 may reflect the added transportation route and the changed (or new) transportation ratio to the next year's transportation routes and the next year's transportation ratio.

Referring to FIG. 26, in operation S523, the cargo volume transportation ratio calculating part 220 may allocate cargo volume to the next year's transportation routes depending on the next year's transportation routes and the next year's transportation ratio. The cargo volume may be received in operation S517 described above.

For example, the cargo volume for the first model may be calculated as follows. The number of first models may be 1000; the total weight for the first model may be 1 ton (or 1 metric ton or 1000 kg); the number of 10-ton trucks to load the first model may be 20; the number of 20-ton trucks to load the first model may be 10; and the number of containers to load the first model may be 10. Hereinafter, the routes in FIG. 27 will be described as an example. The next year's transportation ratio for the first, second, and third routes RT1, RT2, and RT3 shown in FIG. 27 may be “6:2:2”.

The number of first models may be differently determined for each route. For example, the number of first models allocated to the first route RT1 may be 600; the number of first models allocated to the second route RT2 may be 200; and the number of first models allocated to the third route RT3 may be 200. The weight for the first model may be differently determined for each route. For example, the weight allocated to the first route RT1 may be 600 kg; the weight allocated to the second route RT2 may be 200 kg; and the weight allocated to the third route RT3 may be 200 kg. The number of 10-ton trucks may be differently determined for each route. For example, the number of 10-ton trucks allocated to the first route RT1 may be 12; the number of 10-ton trucks allocated to the second route RT2 may be 4; and the number of 10-ton trucks allocated to the third route RT3 may be 4. The number of 20-ton trucks may be differently determined for each route. For example, the number of 20-ton trucks allocated to the first route RT1 may be 6; the number of 20-ton trucks allocated to the second route RT2 may be 2; and the number of 20-ton trucks allocated to the third route RT3 may be 2. The number of containers may be differently determined for each route. For example, the number of containers allocated to the first route RT1 may be 6; the number of containers allocated to the second route RT2 may be 2; and the number of containers allocated to the third route RT3 may be 2. Although not described, in FIGS. 28 and 29, the cargo volume may be allocated to the next year's transportation routes in the same manner depending on the next year's transportation ratio.

In operation S524, the cargo volume transportation ratio calculating part 220 may check whether an error occurs in cargo volume distribution. For example, the next year's transportation ratio for the first, second, and third routes RT1, RT2, and RT3 shown in FIG. 27 may be 6:2:2. Due to an error in calculation, the number of 10-ton trucks allocated to the first route RT1 may be 12, and the number of 10-ton trucks allocated to the second route RT2 may be 4. However, 10-ton trucks may not be allocated to the third route RT3.

In case that an error occurs in cargo volume distribution in operation S524, the procedure may proceed to operation S525. In operation S525, the error in cargo volume distribution may be notified to the user through the user terminal 10′. In operation S526, the user may review an error part and may correct the error part. For example, the number of 10-ton trucks allocated to the third route RT3 may be 4. The number of 10-ton trucks allocated to the third route RT3 may be entered into the cargo volume transportation ratio calculating part 220 through the user terminal 10′. Afterward, in operation S524, an operation of checking an error may be performed, and this operation may be performed until the error is corrected.

In case that an error does not occur in cargo volume distribution in operation S524, the procedure may proceed to operation S527. In operation S527, the cargo volume transportation ratio calculating part 220 may finalize the cargo volume ratio for transportation routes of next year's production products. Afterwards, the procedure may proceed to operation S534.

FIG. 30 is a flowchart for describing an operation of a first logistics cost calculating part shown in FIG. 22.

Referring to FIG. 30, the first logistics cost calculating part 230 may perform an operation of calculating logistics costs in the next year. To this end, operation S530 of calculating logistics costs in the next year may include operations S531 to S538 shown in FIG. 30.

Information about past transportation cost items for past transportation routes of past production products may be stored in the second database DB2.

In operation S531, the first logistics cost calculating part 230 may receive past transportation cost items for past transportation routes of past production products from the second database DB2.

According to the above-described example, the first model of next year's production products may have a past performance, and the second model of next year's production products may not have a past performance.

In case of the first model, the first logistics cost calculating part 230 may receive past transportation cost items of past transportation routes for the first model from the second database DB2. In case of the second model, the first logistics cost calculating part 230 may receive past transportation cost items of past transportation routes of the same product family as the second model from the second database DB2.

Hereinafter, the past transportation cost items for the routes in FIG. 27 will be described. The transportation cost items may include various items such as air transportation fees, vessel transportation fees, truck transportation fees, customs clearance fees, port usage fees, and airport usage fees. However, these items may be described as an example, and there may be more transportation cost items.

In case that products are transported through the first, second, and third routes RT1, RT2, and RT3 shown in FIG. 27, transportation cost items for each of the first, second, and third routes RT1, RT2, and RT3 may be present.

In the first, second, and third routes RT1, RT2, and RT3, the first point P1 and the second points P2-1, P2-2, and P2-3 may be regions of a first nation NT1, and the third points P3-1 and P3-2 and the fourth point P4 may be regions of a second nation NT2.

10-ton trucks, a vessel, and 10-ton trucks have been used in the first route RT1 including the first point P1, the second point P2-1, the third point P3-1, and the fourth point P4. The transportation cost items may include a transportation fee per 10-ton truck from the first point P1 to the second point P2-1, a transportation fee per container loaded on a vessel from the second point P2-1 to the third point P3-1, a transportation fee per 10-ton truck from the third point P3-1 to the fourth point P4, a customs clearance fee at each of the second point P2-1 and the third point P3-1, and a port usage fee at each of the second point P2-1 and the third point P3-1. Each of the second point P2-1 and the third point P3-1 may include a port.

20-ton trucks, an aircraft of a first airline, and 20-ton trucks have been used in the second route RT2 including the first point P1, the second point P2-2, the third point P3-2, and the fourth point P4. The transportation cost items may include a transportation fee per 20-ton truck from the first point P1 to the second point P2-2, a transportation fee per kilogram of cargo loaded on an aircraft of a first airline from the second point P2-2 to the third point P3-2, a transportation fee per 20-ton truck from the third point P3-2 to the fourth point P4, a customs clearance fee at each of the second point P2-2 and the third point P3-2, and an airport usage fee at each of the second point P2-2 and the third point P3-2. Each of the second point P2-2 and the third point P3-2 may include an airport.

The transportation fee per 10-ton truck in the first nation NT1 may be different from the transportation fee per 10-ton truck in the second nation NT2. Moreover, the transportation fee per 20-ton truck in the first nation NT1 may be different from the transportation fee per 20-ton truck in the second nation NT2.

An aircraft of the second airline, a vessel, and 10-ton trucks have been used in the third route RT3 including the first point P1, the second point P2-3, the third point P3-2, and the fourth point P4. The transportation cost items may include a transportation fee per kilogram of cargo loaded on an aircraft of the second airline from the first point P1 to the second point P2-3, a transportation fee per container loaded on a vessel from the second point P2-3 to the third point P3-2, a transportation fee per 10-ton truck from the third point P3-2 to the fourth point P4, a customs clearance fee at each of the second point P2-3 and the third point P3-2, airport usage fees, and port usage fees. Each of the second point P2-3 and the third point P3-2 may include airports or ports, which may be adjacent to each other.

In the first, second, and third routes RT1, RT2, and RT3, a transportation fee per truck, a transportation fee per kilogram of cargo loaded on an aircraft, a transportation fee per container loaded on a vessel, a customs clearance fee, and airport and port usage fees may vary.

In operation S531, the first logistics cost calculating part 230 may receive past transportation cost items for the past transportation routes from the second database DB2.

The past transportation cost items for past transportation routes may be data collected for one year ago. However, an embodiment may not be limited thereto. Depending on the user's settings, data collected for 2, 3, or 5 years ago may be statistically calculated, and then may be provided to the first logistics cost calculating part 230 as past transportation cost items for past transportation routes.

In operation S532, the first logistics cost calculating part 230 may calculate new transportation cost items for next year's transportation routes by reflecting freight rate fluctuations and exchange rate fluctuations to past transportation cost items. The freight rate fluctuations and the exchange rate fluctuations may be current freight rates and exchange rates compared to the past.

For example, the transportation fee per 10-ton truck on the first route RT1 may have changed compared to the past. Furthermore, the exchange rate of the second nation NT2 has changed, and thus the transportation fee per 10-ton truck in the second nation NT2 may have changed compared to the past. Besides, the customs clearance fee, the port usage fee, and the airport usage fee on each of the first, second, and third routes RT1, RT2, and RT3 may have changed compared to the past.

In operation S532, the new transportation cost items may be calculated by reflecting the freight rate fluctuations and exchange rate fluctuations to the past transportation cost items. The new transportation cost items may be used for next year's transportation routes. The user may provide the freight rate fluctuations and the exchange rate fluctuations to the first logistics cost calculating part 230. For example, the user may provide the freight rate fluctuations and the exchange rate fluctuations to the first logistics cost calculating part 230 through the user terminal 10′. The first logistics cost calculating part 230 may apply the freight rate fluctuations and the exchange rate fluctuations, which may be provided through the user terminal 10′, to the past transportation cost items.

According to the above-described example, the first model of next year's production products may have a past performance, and the second model of next year's production products may not have a past performance.

In operation S532, the first logistics cost calculating part 230 may calculate new transportation cost items for the first model (e.g., reflecting the freight rate fluctuations and the exchange rate fluctuations) by using past transportation cost items for the first model stored in the second database DB2. Besides, in operation S532, the first logistics cost calculating part 230 may calculate new transportation cost items for the second model (e.g., reflecting the freight rate fluctuations and the exchange rate fluctuations) by using past transportation cost items of the same product family as the second model stored in the second database DB2.

As shown in FIG. 29, next year's transportation routes may include a new transportation route. Freight rate items for the new transportation route may not be stored in the second database DB2. In operation S533, the first logistics cost calculating part 230 may receive, from the user, new transportation cost items for the new transportation route among the next year's transportation routes. For example, the user may enter the new transportation cost items for the new transportation route into the first logistics cost calculating part 230 through the user terminal 10′. Operation S533 may proceed in parallel with operation S531 and operation S532.

In operation S534, the first logistics cost calculating part 230 may calculate logistics costs for next year's transportation routes by reflecting the new transportation cost items to the cargo volume allocated to the next year's transportation routes. The cargo volume allocated to the next year's transportation routes may be received in operation S527 described above.

In the first route RT1 of FIG. 27, trucks, a vessel, and trucks may be used, and 10-ton trucks among the trucks may be used. The cargo volume of the first route RT1 for the first model of the next year may be twelve 10-ton trucks and six containers. The six containers may be loaded on a vessel.

As described above, the new transportation cost items for the first route RT1 may include a transportation fee per truck and a transportation fee per container. Accordingly, the transportation fee of a truck for the first route RT1 may be calculated by multiplying the transportation fee per 10-ton truck by 12 trucks. Also, the transportation fee for a vessel may be calculated by multiplying the transportation fee per container by 6 containers. Moreover, the transportation fee may be further calculated by using the customs clearance fee and port usage fee corresponding to the first route RT1.

The transportation fee for 10-ton trucks from the first point P1 to the second point P2-1 may be calculated; the transportation fee of a vessel from the second point P2-1 to the third point P3-1 may be calculated; and the transportation fee for 10-ton trucks from the third point P3-1 to the fourth point P4 may be calculated. Furthermore, in the first route RT1, the transportation fee may be further calculated by using the customs clearance fee and port usage fee corresponding to the 600 first models.

For example, in the second route RT2 of FIG. 27, trucks, an aircraft, and trucks may be used, and 20-ton trucks among the trucks may be used. The cargo volume of the second route RT2 for the first model of the next year may be two 20-ton trucks and a weight of 200 kg. The first model of 200 kg may be loaded onto the aircraft.

As described above, new transportation cost items for the second route RT2 may include a transportation fee per 20-ton truck and a transportation fee per kilogram. The truck's transportation fee for the second route RT2 may be calculated by multiplying the transportation fee per 20-ton truck by 2 trucks. The transportation fee for an aircraft of the first airline may be calculated by multiplying the transportation fee per kilogram by the weight of 200 kg.

The transportation fee for 20-ton trucks from the first point P1 to the second point P2-2 may be calculated; the transportation fee of an aircraft of the first airline from the second point P2-2 to the third point P3-2 may be calculated; and the transportation fee for 20-ton trucks from the third point P3-2 to the fourth point P4 may be calculated. Furthermore, in the second route RT2, the transportation fee may be further calculated by using the customs clearance fee and port usage fee corresponding to the 200 first models.

According to the above-described method, the transportation fee for the third route RT3 may also be calculated. Accordingly, the next year's logistics cost for the first, second, and third routes RT1, RT2, and RT3 shown in FIG. 27 may be calculated. Next year's logistics costs for routes in FIG. 28 and routes in FIG. 29 may also be calculated in the same method.

In operation S535, the first logistics cost calculating part 230 may check whether an error occurs in logistics cost calculation. For example, the next year's transportation ratio for the first, second, and third routes RT1, RT2, and RT3 shown in FIG. 27 may be “6:2:2”. However, new logistics costs may not be reflected to the cargo volume ratio in the third route RT3 due to an error in calculation, and thus the logistics cost for the third route RT3 may not be calculated.

In case that an error occurs in calculating the logistics cost in operation S535, the procedure may proceed to operation S536. In operation S536, the error in cargo volume distribution may be notified to the user through the user terminal 10′. In operation S537, the user may review an error part and may correct the error part. For example, with respect to the third route RT3, the user may calculate the logistics cost for the third route RT3 by directly reflecting the new logistics costs to the cargo volume ratio. Afterward, the procedure may proceed to operation S535. In operation S535, an error in logistics cost calculation may be checked. This checking operation may be performed until the error is corrected.

In case that no error occurs in calculating logistics cost in operation S535, the procedure may proceed to operation S538. In operation S538, the first logistics cost calculating part 230 may finalize a next year's logistics cost plan for products to be produced in the next year.

FIGS. 31 and 32 are flowcharts for describing an operation of a per-piece logistics cost calculating part shown in FIG. 22.

Referring to FIG. 31, the per-piece logistics cost calculating part 240 may calculate per-piece logistics costs for past transportation costs. To this end, operation S540 of calculating a per-piece logistics cost may include operations S541 to S543 shown in FIG. 31.

In operation S541, the per-piece logistics cost calculating part 240 may calculate the logistics cost for each past transportation route of a past production product. For example, referring to FIG. 27, because products have been transported in a ratio of “5:3:2” through the first, second, and third routes RT1, RT2, and RT3 in the past, the logistics cost for each of the past transportation routes may be calculated by identifying transportation fees for each of the first, second, and third routes RT1, RT2, and RT3.

In operation S542, the per-piece logistics cost calculating part 240 may calculate the number of products transported through each of past transportation routes. For example, referring to FIG. 27, in case that 1,000 products have been transported in a ratio of “5:3:2” on the first, second, and third routes RT1, RT2, and RT3 in the past, 500, 300, and 200 products may have been transported on the first, second, and third routes RT1, RT2, and RT3, respectively.

In operation S543, the per-piece logistics cost calculating part 240 may calculate per-piece logistics cost for each past transportation route by dividing the logistics cost for each past transportation route by the number of products transported through each past transportation route.

The unit price for a per-piece transportation cost for each route may be identified by calculating the per-piece transportation cost. These calculation results may be used in case that the transportation ratio for next year's transportation routes is adjusted. For example, in case that the per-piece logistics cost for the first route RT1 is smaller than the per-piece logistics cost for the second route RT2, the transportation ratio for the first route RT1 may be increased, and the transportation ratio for the second route RT2 may be decreased.

Transportation costs for transportation routes may be compared through per-piece transportation costs. Accordingly, in the next year's transportation plan, with reference to per-piece transportation costs, a business operator may decrease the transportation ratio for a route having high per-piece transportation costs, and may increase the transportation ratio for a route having low per-piece transportation costs.

The routes shown in FIG. 27 have been described. However, per-piece transportation costs for the routes shown in FIGS. 28 and 29 may also be calculated in the same method.

Referring to FIG. 32, the per-piece logistics cost calculating part 240 may further calculate per-piece logistics cost for each transportation segment. To this end, operation S550 of calculating a per-piece logistics cost for respective transportation segments may include operations S551 to S553 shown in FIG. 32.

In operation S551, the per-piece logistics cost calculating part 240 may calculate the logistics cost for each past transportation segment. For example, referring to FIG. 27, on the first route RT1 in the past, 10-ton trucks may be used from the first point P1 to the second point P2-1; a vessel may be used from the second point P2-1 to the third point P3-1; and 10-ton trucks may be used from the third point P3-1 to the fourth point P4.

The transportation fee of 10-ton trucks may be identified from the first point P1 to the second point P2-1. The transportation fee of the vessel may be identified from the second point P2-1 to the third point P3-1. The transportation fee of 10-ton trucks may be identified from the third point P3-1 to the fourth point P4.

In operation S552, the per-piece logistics cost calculating part 240 may calculate the number of products transported for each past transportation segment. The number of products loaded on trucks may be identified from the first point P1 to the second point P2-1. The number of products loaded in the vessel may be identified from the second point P2-1 to the third point P3-1. The number of products loaded on trucks may be identified from the third point P3-1 to the fourth point P4.

In operation S553, the per-piece logistics cost calculating part 240 may calculate the per-piece logistics cost for each transportation segment by dividing the logistics cost for each past transportation segment by the number of products transported for each past transportation segment. For example, from the first point P1 to the second point P2-1, the per-piece logistics cost for truck transportation may be calculated by dividing the transportation fee of trucks by the number of products loaded onto the truck. From the second point P2-1 to the third point P3-1, the per-piece logistics cost for vessel transportation may be calculated by dividing the transportation fee of a vessel by the number of products loaded onto the vessel. From the third point P3-1 to the fourth point P4, the per-piece logistics cost for truck transportation may be calculated by dividing the transportation fee of trucks by the number of products loaded onto the trucks.

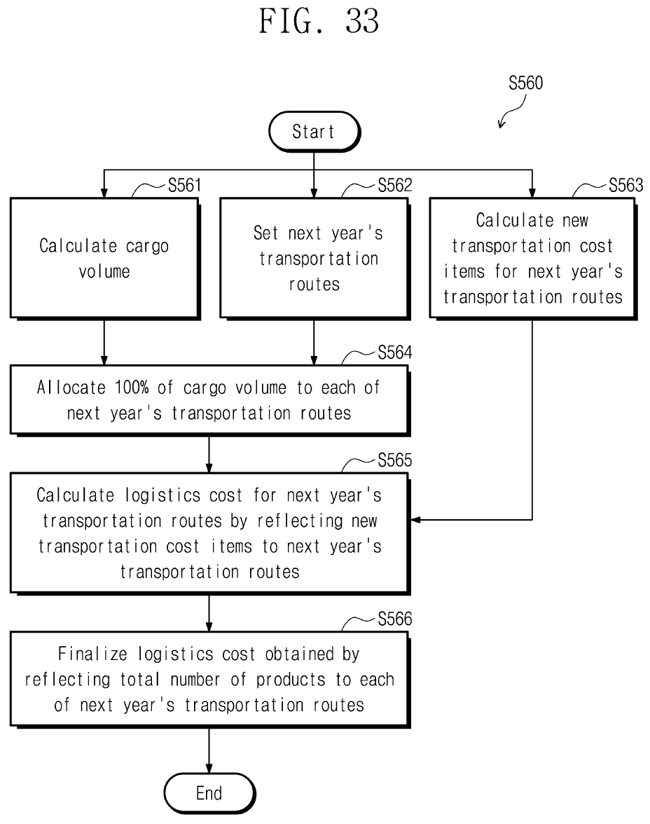

FIG. 33 is a flowchart for describing an operation of a second logistics cost calculating part shown in FIG. 22. FIG. 34 is a diagram showing cargo volume allocated to routes in case that an operation of a second logistics cost calculating part shown in FIG. 33 is reflected to routes for a first model shown in FIG. 27.

Referring to FIG. 33, in case that reflecting 100% of cargo volume to each of the next year's transportation routes, the second logistics cost calculating part 250 may calculate the logistics cost for next year's transportation routes. To this end, operation S560 of calculating logistics costs for the next year's transportation routes may include operations S561 to S566 shown in FIG. 33.

In operation S561, the second logistics cost calculating part 250 may calculate the cargo volume. The cargo volume calculation operation in operation S561 may be substantially the same as a cargo volume calculation operation shown in FIG. 23.

In operation S562, the second logistics cost calculating part 250 may set the next year's transportation routes. An operation of setting the next year's transportation routes in operation S562 may be the same as an operation of deleting a past transportation ratio in operations S521 and S522 of FIG. 26. For example, referring to FIG. 27, the first, second, and third routes RT1, RT2, and RT3 in the past may be set as next year's transportation routes. For example, referring to FIG. 29, the fourth route RT4 may be added to the first, second, and third routes RT1, RT2, and RT3 in the past and thus the first to fourth routes RT1 to RT4 may be set as next year's transportation routes. However, the transportation ratio for the routes may not be reflected.

In operation S563, the second logistics cost calculating part 250 may calculate new transportation cost items for the next year's transportation routes. The operation of calculating new transportation cost items in operation S563 may be the same as operation S531 and operation S532 of FIG. 30.

Operations S561, S562, and S563 may proceed in parallel.

The procedure may proceed to operation S564 after operations S561 and S562. In operation S564, the second logistics cost calculating part 250 may allocate 100% of the cargo volume to each of the next year's transportation routes. For example, referring to FIG. 27, the cargo volume of the first model may be 1000 units, the weight of 1 ton, twelve 10-ton trucks, six 20-ton trucks, and six containers.

Referring to FIGS. 27, 33, and 34, 100% of the cargo volume may be allocated to each of the first route RT1, the second route RT2, and the third route RT3. Accordingly, 1000 units, the weight of 1 ton, twelve 10-ton trucks, six 20-ton trucks, and six containers may be allocated to the first route RT1. Moreover, 1000 units, the weight of 1 ton, twelve 10-ton trucks, six 20-ton trucks, and six containers may be allocated to each of the second route RT2 and the third route RT3.

Referring to FIG. 33, the procedure may proceed to operation S565 after operations S563 and S564. In operation S565, the second logistics cost calculating part 250 may calculate the logistics cost for the next year's transportation routes by reflecting new transportation cost items to the next year's transportation routes. In other words, in case that 100% of the cargo volume may be allocated to each of the next year's transportation routes, the logistics cost for each of the next year's transportation routes may be calculated.

In operation S566, the second logistics cost calculating part 250 may finalize the logistics cost obtained by reflecting the total number of products to each of the next year's transportation routes and may provide the finalized logistics cost to the user terminal 10′. The user may identify the logistics cost, which may be obtained by reflecting the total number of products to each of the next year's transportation routes, through the user terminal 10′. Independently of the first logistics cost calculating part 230, the user may identify the logistics cost for each route, which may be obtained by reflecting the total number of products to each of the next year's transportation routes, through the second logistics cost calculating part 250.

According to the first and second logistics cost calculating parts 230 and 250 and the per-piece logistics cost calculating part 240, the user may identify the logistics costs according to various settings. Accordingly, the convenience of the user may be improved.

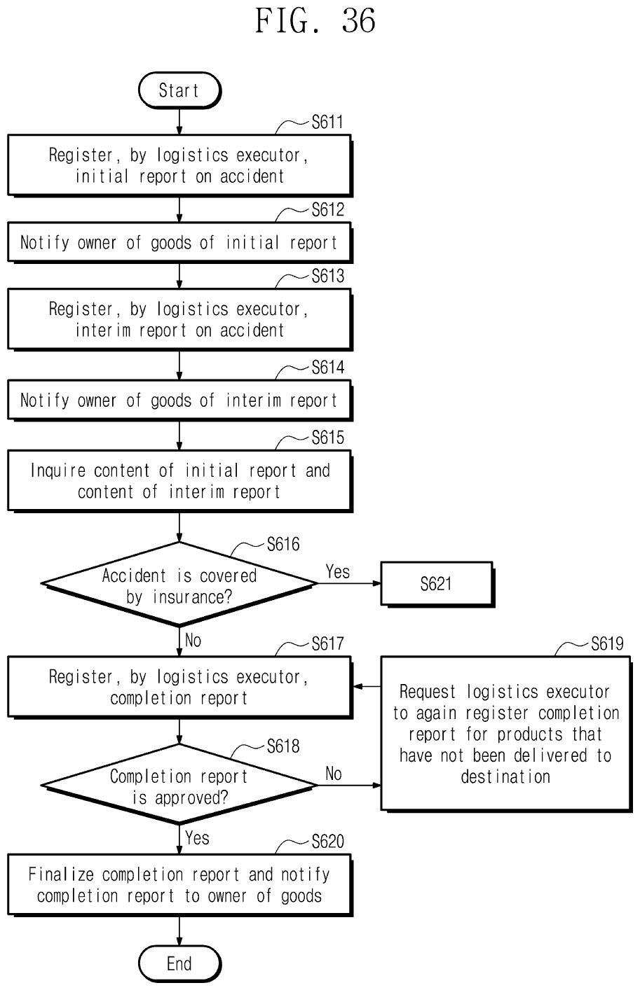

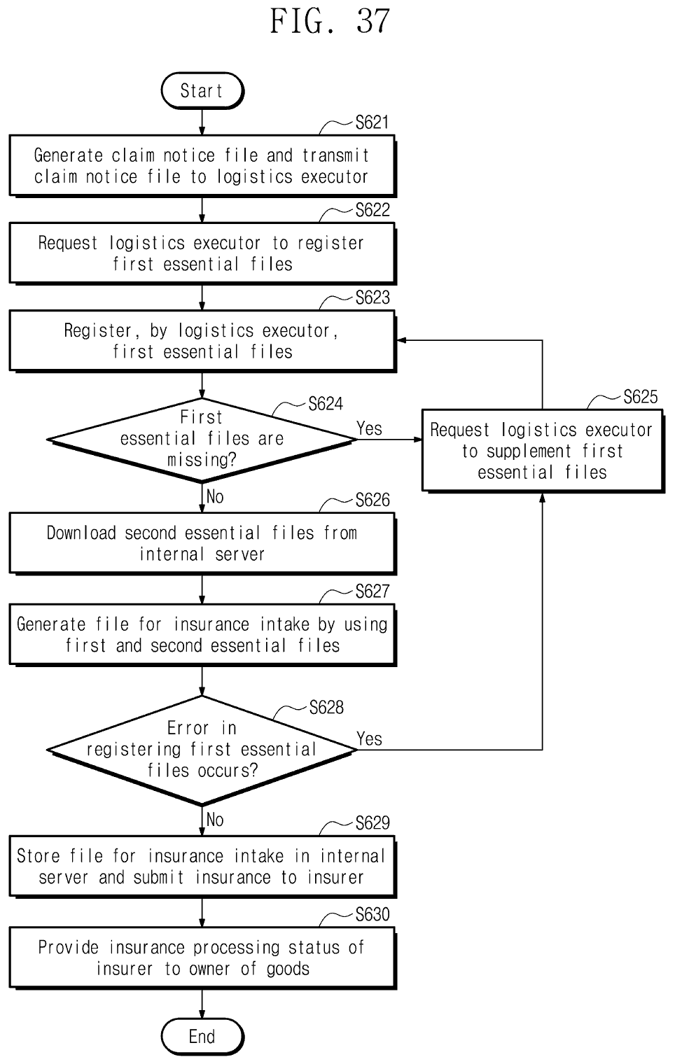

FIG. 35 is a block diagram of an insurance accident managing server shown in FIG. 2. FIG. 36 is a flowchart for describing an operation of an accident registration processing part shown in FIG. 35. FIG. 37 is a flowchart for describing an operation of an insurance intake automation part shown in FIG. 35.

Referring to FIG. 35, the insurance accident managing server 300 may include an accident registration processing part 310 that processes registration for an accident, an insurance intake automation part 320 that submits insurance documents to an insurer by using essential files required for insurance and an insurance intake file in case that the accident may be covered by insurance.

A logistics executor terminal 30-1 may be a terminal of a business operator in charge of logistics transportation. The logistics executor terminal 30-1 may be a freight forwarder terminal 30 for a vessel shown in FIG. 3. Moreover, the logistics executor terminal 30-1 may be a terminal of a business operator that forwards the transportation of logistics by air or truck.

The logistics executor terminal 30-1 may communicate with the accident registration processing part 310. The logistics executor may enter accident situations into the accident registration processing part 310 through the logistics executor terminal 30-1. The accident registration processing part 310 may receive an initial report, an interim report, and a completion report on an accident through the logistics executor terminal 30-1. The accident registration processing part 310 may provide the goods-owner terminal 10 with the initial report, the interim report, and the completion report. An owner of goods may identify the initial report, the interim report, and the completion report for the accident through the goods-owner terminal 10.

The goods-owner terminal 10 may communicate with the logistics executor terminal 30-1 and may immediately receive a notification of an initial accident via an email or a text message. For example, before entering accident situations into the accident registration processing part 310, a logistics executor may immediately transmit the initial incident to the goods-owner terminal 10 via an email or a text message through the logistics executor terminal 30-1.

In case that the accident is covered by insurance, the insurance intake automation part 320 may receive first essential files including accident items, a starting point, a destination, and accident photos from the logistics executor, and may download second essential files including an invoice and a packing list from an internal server. Afterward, the insurance intake automation part 320 may generate the insurance intake file by using the first essential files and the second essential files and may submit the generated insurance intake file to an insurer. Afterwards, the insurance intake automation part 320 may provide the insurer's insurance processing status to the goods-owner terminal 10.

Referring to FIGS. 35 and 36, an accident registration processing operation of the accident registration processing part 310 may be performed through operations S611 to S620.

In operation S611, the logistics executor may register an initial report on an accident. For example, in case that an initial accident occurs, the logistics executor may enter the initial report on the accident into the accident registration processing part 310 through the logistics executor terminal 30-1.

In operation S612, the accident registration processing part 310 may notify the owner of goods of the initial report. For example, the accident registration processing part 310 may provide the initial report to the goods-owner terminal 10. The owner of goods may identify the initial report through the goods-owner terminal 10.

After the accident occurs, an interim situation regarding the handling of the accident needs to be reported to the owner of goods. Accordingly, in operation S613, the logistics executor may register the interim report on the accident. For example, the logistics executor may enter the interim report on the accident into the accident registration processing part 310 through the logistics executor terminal 30-1.

In operation S614, the accident registration processing part 310 may notify the owner of goods of the interim report. For example, the accident registration processing part 310 may provide the interim report to the goods-owner terminal 10. The owner of goods may identify the interim report through the goods-owner terminal 10.

In operation S615, the owner of goods may inquire the content of the initial report and the content of the interim report. In operation S616, it may be determined whether the accident may be covered by insurance. In case that the accident is covered by insurance, after operation S616, the procedure may proceed to operation S621 to perform an insurance intake automation operation. In case that the accident is not covered by insurance, after operation S616, the procedure may proceed to operation S617. In operation S617, the logistics executor may register the completion report.

The accident may be a simple transportation delay. In case that a canal on the vessel's movement route is temporarily closed, an operation of a vessel loaded with cargo may be delayed. The operation of the vessel may be delayed, but there may be no damage to the cargo. In case that there is no damage to the cargo, the accident may not be covered by insurance. However, the vessel may sink due to a typhoon, and thus the cargo may be damaged. In case that there is damage to the cargo, the accident may be determined to be covered by insurance. In practice, in operation S616, whether the accident may be covered by insurance may be determined by the owner of the goods.

In operation S617, in practice, in case that the cargo is delivered to its destination without damage, the logistics executor may register the completion report. The completion report may be a completion report on a simple transportation delay incident. The logistics executor may enter the completion report on the accident into the accident registration processing part 310 through the logistics executor terminal 30-1.

In operation S618, the accident registration processing part 310 may determine whether the completion report may be approved. For example, the cargo may include a first product and a second product; a vessel has been used for transportation; and, depending on local situations upon departure, the first product may be transported by a first vessel and the second product may be transported by a second vessel while the first product and second product may be separated from each other. In case that a delay incident for the first vessel is completely registered, only the first product may arrive at the destination.

The second product may not have arrived at the destination due to a delay in the second vessel. The completion report may not be approved. In case that the completion report is not approved, the procedure may proceed to operation S619 after operation S618. In operation S619, the accident registration processing part 310 may request the logistics executor to again register a completion report for products that have not been delivered to the destination. The request for re-registration of completion report may be notified to the logistics executor through the logistics executor terminal 30-1.

The procedure may proceed to operation S617 after operation S619. In operation S617, the logistics executor may re-register the completion report in case that the second product arrives at the destination.

In operation S618, in case that both the first product and the second product have arrived at the destination, the accident registration processing part 310 may approve the completion report. The procedure may proceed to operation S620 after operation S618. In operation S620, the accident registration processing part 310 may finalize the completion report and may notify the completion report to the owner of goods through the goods-owner terminal 10.

Referring to FIGS. 35, 36, and 37, an insurance intake automation operation of the insurance intake automation part 320 may be performed through operations S621 to S630.

In case that the accident is covered by insurance, the procedure may proceed to operation S621 after operation S616. In operation S621, the insurance intake automation part 320 may generate a claim notice file and may transmit the claim notice file to the logistics executor. The insurance intake automation part 320 may transmit the claim notice file to the logistics executor through the logistics executor terminal 30-1.

Items in the claim notice file may include accident history items and expected damage items. Through the claim notice file, the logistics executor may identify that the accident may be covered by insurance processing.

In operation S622, the insurance intake automation part 320 may request the logistics executor to register first essential files through the logistics executor terminal 30-1. The first essential files may include a bill of lading (in case of a vessel accident), customer information, accident items, a starting point, a destination, and accident photos.

In operation S623, the logistics executor may access the insurance intake automation part 320 through the logistics executor terminal 30-1 and may register the first essential files in the insurance intake automation part 320.

In operation S624, the insurance intake automation part 320 may determine whether the first essential files may be missing. The insurance intake automation part 320 may request first to sixth items as the first essential files. For example, the six items such as a bill of lading, customer information, an accident item, a starting point, a destination, and an accident photo may be requested as the first essential files. The logistics executor may register the first essential files in the first to sixth items of the insurance intake automation part 320.

In case that all the first essential files are not registered, the insurance intake automation part 320 may determine that the first essential files may be missing. In case that the first essential files are missing, the procedure may proceed to operation S625 after operation S624. In operation S625, the insurance intake automation part 320 may request the logistics executor to supplement the first essential files. After operation S625, the procedure may proceed to operation S623. In operation S623, the logistics executor may register the first essential files thus missing in the insurance intake automation part 320.

In case that all the first essential files are registered in the first to sixth items of the insurance intake automation part 320, the insurance intake automation part 320 may determine that all the first essential files are registered. After operation S624, the procedure may proceed to operation S626. In operation S626, the insurance intake automation part 320 may download second essential files from an internal server.

The second essential files may include an invoice (I/V) and a packing list (P/L). Detailed information of cargo may be obtained through the invoice and the packing list. The first and second essential files may be defined as essential files required for insurance intake.

In operation S627, the insurance intake automation part 320 may generate a file for insurance intake by using the first and second essential files.

In operation S628, a registration error in the first essential files may be identified. For example, the owner of goods may access the insurance intake automation part 320 through the goods-owner terminal 10 to identify the registration error in the first essential files.

The checking operation in operation S624 may only check whether the first essential files may be registered in the first to sixth items of the insurance intake automation part 320. However, the following error may occur.

The logistics executor may normally enter a bill of lading, customer information, an accident item, a starting point, a destination, and an accident photo in the first to sixth items, respectively. However, the logistics executor may accidentally enter the bill of lading, the customer information, the accident item, the starting point, the starting point, and the starting point into the first to sixth items, respectively. In other words, the first essential files may be correctly registered in the first to fourth items, but incorrect first essential files may be registered in the fifth and sixth items.

In operation S628, the owner of goods may check an error in registering the first essential files. In case that there is an error in registering the first essential files, the procedure may proceed to operation S625 after operation S628. In operation S625, the logistics executor may be requested to supplement the first essential files through the insurance intake automation part 320.

In case that there is no error in registering the first essential files, the procedure may proceed to operation S629 after operation S628. In operation S629, the insurance intake automation part 320 may store a file for insurance intake in the internal server and may submit insurance to the insurer. Although not shown in drawings, the insurance intake automation part 320 may substantially submit an insurance intake file to the insurer's server.

In operation S630, the insurance intake automation part 320 may provide an insurance processing status of the insurer to the owner of goods. The insurance processing status of the insurer may be provided to the owner of goods through the goods-owner terminal 10.

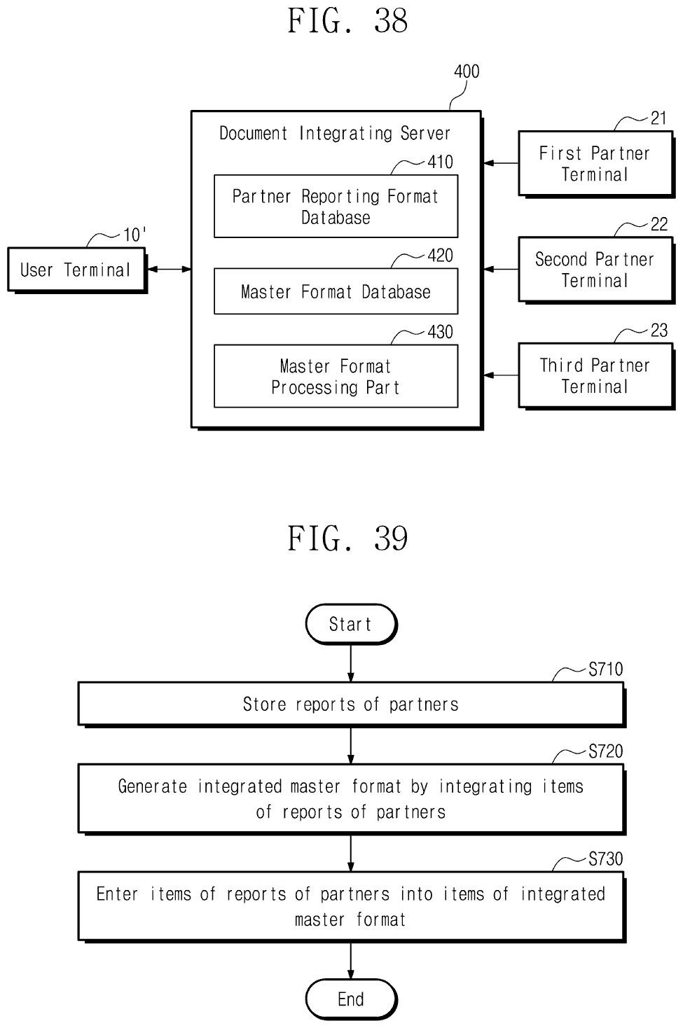

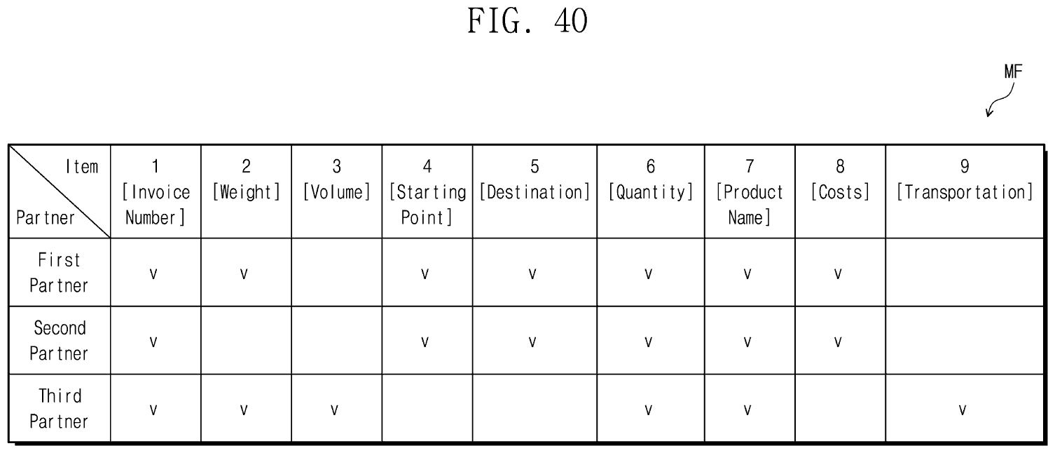

FIG. 38 is a block diagram of a document integrating server shown in FIG. 2. FIG. 39 is a flowchart for describing an operation of a document integrating server shown in FIG. 38. FIG. 40 is a diagram showing an integrated master format processed depending on an operation of a document integrating server shown in FIG. 38.

Referring to FIG. 38, the document integrating server 400 may integrate and manage reports from partners. The document integrating server 400 may include a partner reporting format database 410, a master format database 420, and a master format processing part 430. Three partners may be shown in FIG. 38, but the number of partners may not be limited thereto.

First, second, and third partners may access the document integrating server 400 through first, second, and third partner terminals 21, 22, and 23, and may register reports on product transactions in the document integrating server 400. The reports from the first, second, and third partners may be stored in the partner reporting format database 410.

A user may access the document integrating server 400 through the user terminal 10′. The user may be defined as an administrator who manages the document integrating server 400 through the user terminal 10′.

The user may create an integrated master format by integrating items of partners' reports stored in the partner reporting format database 410. The integrated master format may be stored in the master format database 420.

The master format processing part 430 may input items of reports of the partners into items of the integrated master format. For example, the master format processing part 430 may receive the reports of the partners and the integrated master format from the partner reporting format database 410 and the master format database 420. The master format processing part 430 may input the items of a report of each partner into the corresponding items among the items of the integrated master format. The integrated master format, into which the items of the report of each partner may be input, may be provided to the user through the user terminal 10′.

Referring to FIG. 39, in operation S710, the reports of the partners may be stored depending on an operation of the document integrating server 400. In operation S720, the integrated master format may be generated by integrating the items of the reports of the partners. In operation S730, the items of the reports of the partners may be entered into the items of the integrated master format.

Referring to FIG. 40, the report of the first partner may include items such as an invoice number, weight, volume, a starting point, a destination, a quantity, a product name, and costs. The report of the second partner may include items such as an invoice number, a starting point, a destination, a quantity, a product name, and costs. The report of the third partner may include items such as an invoice number, weight, volume, quantity, a product name, and transportation.

The items of first, second, and third partners may be integrated into items 1 to 9 to generate an integrated master format MF, and report items for each of the first, second, and third partners may be entered into the integrated master format MF. The content of the entered item may be omitted, and a field of the entered item may be displayed as “v”.

Because different report formats for each partner may be integrated and provided to the user, the user may more readily identify the items of reports of the partners.

Although described above with reference to an embodiment, it will be understood by those skilled in the art that various modifications and changes may be made in the disclosure without departing from the spirit and scope of the disclosure as set forth in the claims below. Furthermore, embodiments of the disclosure may not be intended to limit the technical spirit of the disclosure. All technical spirit in the scope of the following claims and all equivalents thereof should be construed as being included in the scope of the disclosure.

According to an embodiment of the disclosure, an integrated logistics management system and an integrated logistics management method may provide an owner of goods with a real-time location of transportation, may determine whether the transportation may be delayed based on risk information, and may provide the owner of goods with the determination result, thereby improving convenience in managing transportation for the owner of goods.

Besides, the integrated logistics management system and the integrated logistics management method may efficiently calculate logistics costs for cargo transportation routes, may efficiently manage insurance accidents in the event of a transportation accident, and may efficiently manage reports by integrating the reports from partners.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. An integrated logistics management system, comprising:
a terminal; and
a transportation tracking server configured to communicate with the terminal and to process transportation information about transportation, wherein the transportation tracking server includes a vessel tracking server configured to:
process transportation information about vessels by using pieces of vessel identification information received from the terminal; and
provide the transportation information about the vessels to the terminal, and wherein the vessel tracking server includes:
a vessel-map mapping part configured to receive pieces of navigation information of the vessels corresponding to the pieces of vessel identification information from a vessel information operator server by providing the pieces of vessel identification information to the vessel information operator server, and to map navigation routes of the vessels and real-time locations of the vessels onto a map; and
a vessel-cargo mapping part configured to map vessel cargo information to a corresponding vessel among the vessels.

2. The system of claim 1, wherein
the vessel-map mapping part provides the terminal with navigation information of vessels onto which the vessel cargo information is mapped from among the vessels, and
navigation information of vessels onto which the vessel cargo information is not mapped from among the vessels.

3. The system of claim 1, wherein the vessel tracking server does not receive a bill of lading from the terminal.

4. The system of claim 1, wherein
each of the pieces of vessel identification information includes a vessel name, an international maritime organization (IMO) number, a maritime mobile service identity (MMSI) number, and a Call sign,
the terminal provides the vessel name to the vessel information operator server, and receives the IMO number, the MMSI number, and the Call sign, which correspond to the vessel name, from the vessel information operator server, and
the terminal provides the vessel tracking server with the vessel name, the IMO number, the MMSI number, and the Call sign.

5. The system of claim 1, wherein
the transportation tracking server further includes a risk collecting server configured to collect risk information from a risk information providing server, and
the vessel tracking server receives the risk information from the risk collecting server, and calculates whether the vessel, onto which the vessel cargo information is mapped is delayed based on the risk information.

6. The system of claim 5, wherein
the transportation tracking server further includes a flight tracking server configured to process transportation information about an aircraft and to provide the processed transportation information to the terminal, and wherein the flight tracking server includes:
a flight-map mapping part configured to receive flight information of the aircraft corresponding to a flight number by providing the flight number to a flight information providing server, and to map a flight route of the aircraft and a real-time location of the aircraft onto the map; and
a flight-cargo mapping part configured to map air cargo information onto the aircraft.

7. The system of claim 6, wherein the flight tracking server further includes a flight delay calculating part configured to receive the risk information from the risk collecting server, and to calculate whether the aircraft is delayed based on the risk information.

8. The system of claim 5, wherein
the transportation tracking server further includes a truck tracking server configured to process transportation information about a truck and to provide the processed transportation information to the terminal, and wherein the truck tracking server includes:
a truck-map mapping part configured to receive driving information of the truck corresponding to truck identification information from a transportation operator server by providing the truck identification information to the transportation operator server, and to map a driving route of the truck and a real-time location of the truck onto the map; and
a truck-cargo mapping part configured to map truck cargo information to the truck.

9. The system of claim 8, wherein the truck tracking server further includes a truck delay calculating part configured to receive the risk information from the risk collecting server, and to calculate whether the truck is delayed based on the risk information.

10. The system of claim 8, wherein the truck-map mapping part further receives the real-time location of the truck, which is obtained from a location tracking application matched to the truck from a location tracking information operator server.

11. The system of claim 8, wherein the truck-map mapping part further receives the real-time location of the truck, which is obtained from a location tracking device matched to the truck from a location tracking device operator server.

12. The system of claim 8, wherein the truck tracking server further includes:
an optimal route calculating part configured to calculate a shortest route from a starting point to a destination as an optimal route based on road information about the starting point and the destination of the truck; and
an estimated arrival time calculating part configured to calculate an estimated arrival time of the truck based on past driving records corresponding to the driving route, and
wherein, in case that a plurality of shortest routes in a predetermined error range are calculated, the optimal route calculating part sets a shortest route at a low altitude as the optimal route.

13. The system of claim 1, further comprising:
a logistics cost calculating server configured to calculate a logistics cost, wherein the logistics cost calculating server includes:
a cargo volume calculating part configured to calculate cargo volume by calculating total weight of next year's production products, a number of trucks to load the next year's production products, and the number of containers to load the next year's production products depending on the number of the next year's production products, per-piece weight of the next year's production products, and per-piece volume of the next year's production products;
a cargo volume transportation ratio calculating part configured to determine next year's transportation routes and a transportation ratio of the next year's transportation routes based on past transportation routes of past production products corresponding to the next year's production products and a past transportation ratio of the past transportation routes, and to allocate the cargo volume to the next year's transportation routes depending on the next year's transportation routes and the transportation ratio of next year's transportation routes; and
a first logistics cost calculating part configured to calculate new transportation cost items for the next year's transportation routes by reflecting changed freight costs and exchange rate fluctuations to past transportation cost items for the past transportation routes, and to calculate a logistics cost for the next year's transportation routes by reflecting the new transportation cost items to the cargo volume allocated to the next year's transportation routes, and
wherein the first logistics cost calculating part receives new transportation cost items for a new transportation route among the next year's transportation routes from a user.

14. The system of claim 13, wherein the cargo volume calculating part includes a cargo loading rate calculating part configured to identify a size of a cargo compartment of the trucks and a size of each of the containers, and to calculate a maximum loading quantity of a cargo box for the truck and each of the containers depending on a placement direction of a standardized cargo box to load the next year's production products, and a loading condition of the cargo box.

15. The system of claim 13, wherein
the next year's production products include a first model having a past performance and a second model having no past performance,
the cargo volume calculating part receives per-piece weight and per-piece volume for the first model from a first database, and receives per-piece weight and per-piece volume for the second model from the user,
the cargo volume transportation ratio calculating part determines next year's transportation routes and a next year's transportation ratio for the first model by using past transportation routes and a past transportation ratio of the first model, which are provided from a second database, and determines next year's transportation routes and a next year's transportation ratio for the second model by using past transportation routes and past transportation ratio of a same product family as the second model provided from the second database, and
the first logistics cost calculating part calculates new transportation cost items for the first model by using past transportation cost items for the first model stored in the second database, and calculates new transportation cost items for the second model by using past transportation cost items of the same product family as the second model stored in the second database.

16. The system of claim 13, wherein the logistics cost calculating server further includes:
a per-piece logistics cost calculating part configured to calculate per-piece logistics cost for each past transportation route by dividing a logistics cost for each of the past transportation routes by a number of products transported through each of the past transportation routes; and
a second logistics cost calculating part configured to allocate 100% of the cargo volume to each of the next year's transportation routes, and to calculate a logistics cost for each of next year's transportation routes by reflecting the new transportation cost items to each of the next year's transportation routes.

17. The system of claim 1, further comprising:
an insurance accident managing server configured to manage an insurance accident in case that an accident occurs, wherein the insurance accident managing server includes:
an accident registration processing part configured to receive an initial report, an interim report, and a completion report on the accident in case that the accident occurs, and to provide the terminal with the initial report, the interim report, and the completion report; and
an insurance intake automation part configured to receive first essential files including an accident item, a starting point, a destination, and an accident photo from a logistics executor, to download second essential files including an invoice and a packing list from an internal server, and to submit an insurance intake file generated by using the first essential files and the second essential files to an insurer, in case that the accident is covered by insurance.

18. The system of claim 1, further comprising:
a document integrating server configured to integrate reports of partners, wherein the document integrating server includes:
a partner reporting format database configured to store the reports of the partners;
a master format database configured to store an integrated master format obtained by integrating items of the reports of the partners stored in the partner reporting format database; and
a master format processing part configured to input the items of the reports of the partners into an item of the integrated master format.

19. An integrated logistics management method, the method comprising:
processing transportation information about vessels and providing the transportation information about the vessels to a terminal, wherein the processing of the transportation information about the vessels includes:
receiving pieces of vessel identification information from the terminal;
receiving pieces of navigation information of the vessels corresponding to the pieces of vessel identification information from a vessel information operator server by providing the pieces of vessel identification information to the vessel information operator server;
mapping navigation routes of the vessels and real-time locations of the vessels onto a map;
mapping vessel cargo information to a corresponding vessel among the vessels;
collecting risk information from a risk information providing server; and
calculating whether the vessel, onto which the vessel cargo information is mapped, is delayed based on the risk information.

20. The method of claim 19, further comprising:
processing transportation information about an aircraft and providing the processed transportation information to the terminal, wherein the processing of the transportation information about the aircraft includes:
receiving flight information of the aircraft corresponding to a flight number by providing the flight number to a flight information providing server;
mapping a flight route of the aircraft and a real-time location of the aircraft onto the map; and
mapping air cargo information onto the aircraft; and
calculating whether the aircraft is delayed based on the risk information.

21. The method of claim 19, further comprising:
processing transportation information about a truck and providing the processed transportation information to the terminal, wherein the processing of the transportation information about the truck includes:
receiving driving information of the truck corresponding to truck identification information from a transportation operator server by providing the truck identification information to the transportation operator server;
receiving a real-time location of the truck, which is obtained from a location tracking application matched to the truck, from a location tracking information operator server by providing the truck identification information to the location tracking information operator server;
receiving the real-time location of the truck, which is obtained from a location tracking device matched to the truck, from a location tracking device operator server by providing the truck identification information to the location tracking device operator server;
mapping a driving route of the truck and the real-time location of the truck onto the map;
mapping truck cargo information onto the truck; and
calculating whether the truck is delayed based on the risk information.

22. The method of claim 21, wherein the processing of the transportation information about the truck further includes:
calculating a shortest route from a starting point to a destination as an optimal route based on road information about the starting point and the destination of the truck;
in case that a plurality of shortest routes in a predetermined error range are calculated, setting a shortest route at a low altitude as the optimal route; and
calculating an estimated arrival time of the truck based on past driving records corresponding to the driving route.

23. The method of claim 19, further comprising:
calculating a logistics cost, wherein the calculating of the logistics cost includes:
calculating cargo volume by calculating total weight of next year's production products, a number of trucks to load the next year's production products, and the number of containers to load the next year's production products depending on the number of the next year's production products, per-piece weight of the next year's production products, and per-piece volume of the next year's production products;
determining next year's transportation routes and a transportation ratio of the next year's transportation routes based on past transportation routes of past production products corresponding to the next year's production products and a past transportation ratio of the past transportation routes;
allocating the cargo volume to the next year's transportation routes depending on the next year's transportation routes and the transportation ratio of the next year's transportation routes;
calculating new transportation cost items for the next year's transportation routes by reflecting changed freight costs and exchange rate fluctuations to past transportation cost items for the past transportation routes;
receiving new transportation cost items for a new transportation route among the next year's transportation routes from a user; and
calculating a logistics cost for the next year's transportation routes by reflecting the new transportation cost items to the cargo volume allocated to the next year's transportation routes.

24. The method of claim 23, wherein the calculating of the cargo volume includes:
calculating a maximum loading quantity of a cargo box for a truck and each of the containers depending on a placement direction of a standardized cargo box to load the next year's production products, and a loading condition of the cargo box.

25. The method of claim 23, wherein
the next year's production products include a first model having a past performance and a second model having no past performance,
per-piece weight and per-piece volume for the first model are provided from a first database, and per-piece weight and per-piece volume for the second model are provided from the user,
next year's transportation routes and a next year's transportation ratio for the first model are determined by using past transportation routes and a past transportation ratio of the first model, which are stored in a second database,
next year's transportation routes and a next year's transportation ratio for the second model are determined by using past transportation routes and past transportation ratio of a same product family as the second model stored in the second database,
new transportation cost items for the first model are calculated by using past transportation cost items for the first model stored in the second database, and
new transportation cost items for the second model are calculated by using past transportation cost items of the same product family as the second model stored in the second database.

26. The method of claim 23, further comprising:
calculating per-piece logistics cost for each of the past transportation routes by dividing a logistics cost for each of the past transportation routes by a number of products transported through each of the past transportation routes;
allocating 100% of the cargo volume to each of the next year's transportation routes; and
calculating a logistics cost for each of next year's transportation routes by reflecting the new transportation cost items to each of the next year's transportation routes.
